(19) United States
(12) Patent Application Publication
(10) Pub. No.: US 2011/0014967 A1
(43) Pub. Date: Jan. 20, 2011

(54) GAMING MACHINE

(75) Inventor: Kazumasa Yoshizawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: Universal Entertainment Corporation, Koto-ku (JP); Aruze Gaming America, Inc., Las Vegas, NV (US)

(21) Appl. No.: 12/825,957

(22) Filed: Jun. 29, 2010

(30) Foreign Application Priority Data
Jul. 14, 2009 (JP) 2009-166141

(51) Int. Cl. A63F 9/24; A63F 13/00

(52) U.S. Cl. 463/20; 463/30; 463/43

(57) ABSTRACT

A gaming machine of the present invention determines random determination odds based on a character setting selected by a player and a stage setting randomly determined; and randomly determines an amount of increase in the number of bonus symbols 503 in the feature game, based on the random determination odds.

### CROSS REFERENCE TO RELATED APPLICATION

The present application claims priority from provisional application No. 2009-166141 filed on Jul. 14, 2009, the entire disclosure of which is herein incorporated by reference.

### BACKGROUND OF THE INVENTION

1. Field of the Invention

The present invention relates to a gaming machine capable of running a bonus game.

2. Description of Related Art

The following gaming machine has been known. Namely, a game is started on condition that a predetermined amount of bet is placed, and a plurality of symbol columns displayed on a display unit start to scroll. After a predetermined period, the plurality of symbol columns stop scrolling. Based on the symbols stop-displayed after the scrolling, an award is given.

Such a gaming machine is a gaming machine which runs a free game when a predetermined condition (e.g. rearrangement of a particular symbol during a gaming on a slot machine) is met during a game. The free game is a game playable without a need of betting a game media. For example, the specification of the publication of Japanese Unexamined Patent Publication No. 105510/2007 (Tokukai 2007-105510) discloses a gaming machine which runs a sub game as a free game, when a predetermined condition (e.g. a particular arrangement of symbols) is met during a base game.

There has also been a gaming machine which enables a player to select a character for an effect in a free game. Based on the character selected, the benefit of the free game such as the number of free games or the bonus symbols used in the free game is determined. In such a gaming machine, if player does not enter his/her selection, the resulting benefit is randomly selected.

The gaming machine however adopts a simple system for random selection of various benefits in the free game. As such, the number of possible results is small and limited to the small number of selections made available beforehand. Random selection of a result from a wide range of selections have been difficult. Due to this limited range of selections given to a player, the player easily gets board of the game, which consequently leads to a decrease in the number of players participating in the game.

An object of the present invention is to provide a gaming machine providing an entertainment characteristic which is not brought about by the above mentioned prior art, and a playing method thereof.

### SUMMARY OF THE INVENTION

A first aspect of the present invention is a gaming machine, including:

an advantageous condition storage device for storing a plurality of advantageous conditions each related to an advantage level of a player in a game;

an effect setting storage device for storing a plurality of first settings and a plurality of second settings each related to an effect of the game;

a first setting selection button to be operated by the player for selecting one of the plurality of first settings stored in the effect setting storage device; and

a controller,

wherein the controller is programmed to perform the processes of:

(a1) running a base game configured to award a payout according to a predetermined combination;

(a2) when the predetermined condition is met in the base game, shifting a gaming mode to a special game which is more advantageous for the player than the base game;

(a3) receiving an operation of the first setting selection button by the player;

(a4) determining a first setting based on the operation by the player;

(a5) randomly determining a second setting out of the plurality of second settings stored in the effect setting storage device;

(a6) determining the random determination odds based on the combination of the first setting and the second setting;

(a7) based on the random determination odds, randomly determining an advantageous condition out of the plurality of advantageous conditions stored in the advantageous condition storage device; and

(a8) running the special game based on the advantageous condition determined.

In the structure, when the predetermined condition is met in the base game, the first setting is determined based on the operation of the first setting selection button by the player. Further, the second setting is randomly determined. The random determination odds are determined based on a combination of the first setting and the second setting thus determined. Then, the advantageous condition in the special game is randomly determined based on the random determination odds. The special game is run based on the advantageous condition thus determined. As is understood from this, the random determination odds for determining the advantageous condition of the special game are varied, based on the first setting selected by the player and the second setting randomly determined. This gives wider range of variation to the advantageous conditions to be selected than a case of determining the advantageous condition upon selection of the first setting by the player. Therefore, a gaming machine with an entertainment characteristic is provided.

Further, the gaming machine of the first aspect of the present invention may further include a notification device for notifying the player of the advantageous condition, wherein the controller notifies the player of the advantageous condition determined via the notification device.

With the structure, the advantageous condition determined is notified to the player via the notification device. This may enable the player to grasp the level of the advantageous condition by effects such as displaying an image of a character with a stronger item or outputting a larger sound for a better advantageous condition. Thus, there is provided a gaming machine with an improved entertainment characteristic.

Further, the gaming machine of the first aspect of the present invention may further include a display device for displaying an image, wherein the controller displays on the display device a character according to the first setting determined, and an item of the character according to the advantageous condition.

With the structure, a character is displayed on the display device according to the first setting determined. Further, an item of the character is displayed on the display device according to the advantageous condition determined. This may enable the player to grasp the level of the advantageous condition by effects such as displaying an image of a character with a stronger item for a better advantageous condition. Thus, there is provided a gaming machine with an improved entertainment characteristic.

A second aspect of the present invention is a gaming machine, including:

an advantageous condition storage device for storing a plurality of advantageous conditions each related to an advantage level of a player in a game;

an effect setting storage device for storing a plurality of first settings and a plurality of second settings each related to an effect of the game;

a first setting selection button to be operated by the player for selecting one of the plurality of first settings stored in the effect setting storage device;

a second setting selection button to be operated by the player for selecting one of the plurality of second settings stored in the effect setting storage device; and

a controller,

wherein the controller is programmed to perform the processes of:

(b1) running a base game configured to award a payout according to a predetermined combination;

(b2) when the predetermined condition is met in the base game, shifting a gaming mode to a special game which is more advantageous for the player than the base game;

(b3) receiving an operation of the first setting selection button and the second setting selection button by the player;

(b4) determining the first setting and the second setting based on the operation by the player;

(b5) determining the random determination odds based on the first setting and the second setting;

(b6) based on the random determination odds, randomly determining an advantageous condition out of the plurality of advantageous conditions stored in the advantageous condition storage device; and

(b7) running the special game based on the advantageous condition determined.

With the structure, when the predetermined condition is met during the base game, the first setting is determined based on an operation of the first setting selection button by the player, and the second setting is determined based on an operation of the second setting selection button by the player. The random determination odds are determined based on a combination of the first setting and the second setting thus determined. Then, the advantageous condition in the special game is randomly determined based on the random determination odds. The special game is run based on the advantageous condition thus determined. As described, the random determination odds for determining the advantageous condition of the special game are varied based on the first setting and the second setting selected by the player. This gives wider range of variation to the advantageous conditions to be selected than a case of determining the advantageous condition upon selection of the first setting by the player. Therefore, a gaming machine with an entertainment characteristic is provided.

Further, the gaming machine of the second aspect of the present invention may further include a notification device for notifying the player of the advantageous condition, wherein the controller notifies the player of the advantageous condition determined via the notification device.

With the structure, the advantageous condition determined is notified to the player via the notification device. This may enable the player to grasp the level of the advantageous condition by effects such as displaying an image of a character with a stronger item or outputting a larger sound for a better advantageous condition. Thus, there is provided a gaming machine with an improved entertainment characteristic.

Further, the gaming machine of the second aspect of the present invention may further include a display device for displaying an image, wherein the controller may display on the display device a character according to the first setting determined and an item of the character according to the advantageous condition determined.

With the structure, a character is displayed on the display device according to the first setting determined. Further, an item of the character is displayed on the display device according to the advantageous condition determined. This may enable the player to visually grasp the level of the advantageous condition by effects such as displaying an image of a character with a stronger item for a better advantageous condition. Thus, there is provided a gaming machine with an improved entertainment characteristic.

A third aspect of the present invention is a playing method of a gaming machine capable of running a base game configured to award a payout according to a predetermined combination, and

running a special game which is more advantageous for the player than the base game,

the method comprising the steps of:

(c1) running the base game;

(c2) when the predetermined condition is met in the base game, shifting a gaming mode to a special game;

(c3) receiving an operation by the player; (c4) based on the operation by the player, determining one of a plurality of first settings for effects of the game;

(c5) randomly determining one of a plurality of second settings for effects of the game;

(c6) determining random determination odds based on a combination of the first setting and the second setting thus determined;

(c7) based on the random determination odds, randomly determining one of a plurality of advantageous conditions in relation to an advantage level of the player in the special game; and

(c8) running the special game based on the advantageous condition determined.

In the structure, when the predetermined condition is met in the base game, the first setting is determined based on the operation of the first setting selection button by the player. Further, the second setting is randomly determined. The random determination odds are determined based on a combination of the first setting and the second setting thus determined. Then, the advantageous condition in the special game is randomly determined based on the random determination odds. The special game is run based on the advantageous condition thus determined. As is understood from this, the random determination odds for determining the advantageous condition of the special game are varied, based on the first setting selected by the player and the second setting randomly determined. This gives wider range of variation to the advantageous conditions to be selected than a case of determining the advantageous condition upon selection of the first setting by the player. Therefore, a gaming machine with an entertainment characteristic is provided.

### Advantageous Effects

In the gaming machine of the present invention, the random determination odds which determine the advantageous condition of the special game are varied based on the first setting selected by the player and the second setting randomly determined. This gives wider range of variation to the advantageous conditions to be selected than a case of determining the advantageous condition upon selection of the first setting by the player. Therefore, a gaming machine with an entertainment characteristic is provided.

### BRIEF DESCRIPTION OF THE DRAWINGS

FIG. 1 is an explanatory diagram showing an overall structure of a slot machine according to an embodiment of the present invention.

FIG. 2 is an explanatory diagram showing an overall structure of the slot machine according to the embodiment of the present invention.

FIG. 3 is a view showing a function flow of the gaming machine according to the embodiment of the present invention.

FIG. 4 is a view showing a gaming system including the slot machine according to the embodiment of the present invention.

FIG. 5 is a view showing the overall structure of the slot machine according to the embodiment of the present invention.

FIG. 6 is a block diagram showing an internal structure of the slot machine of the embodiment, according to the present invention.

FIG. 7 is a block diagram showing the internal structure of the slot machine of the embodiment, according to the present invention.

FIG. 8 shows base game symbol table of symbols drawn on the peripheral surfaces of the reels of the slot machine of the embodiment, according to the present invention.

FIG. 9 shows a payout table indicating relation between an amount of payout and the type and number of symbols arranged on a payline.

FIG. 10 is a corresponding bonus symbol table indicating random determination odds of character equipment according to a character and stage combination, and the corresponding number of bonus symbols.

FIG. 11 is a corresponding random number table indicating the random determination odds of the character equipment and corresponding random numbers.

FIG. 12 is an explanatory diagram of a symbol column determination table provided in the slot machine of the embodiment, according to the present invention.

FIG. 13 is an explanatory diagram of a code number determination table provided in the slot machine of the embodiment, according to the present invention.

FIG. 14A shows an exemplary feature game symbol table indicating each symbol in a symbol column formed by display blocks during a feature game, and code number and random number associated with the symbol.

FIG. 14B shows an exemplary feature game symbol table indicating each symbol in a symbol column formed by display blocks during a feature game, and code number and random number associated with the symbol.

FIG. 15 is an explanatory diagram showing the display state of a symbol display device provided in the slot machine of the embodiment, according to the present invention.

FIG. 16 is an explanatory diagram showing the display state of the symbol display device provided in the slot machine of the embodiment, according to the present invention.

FIG. 17 is an explanatory diagram showing the display state of the symbol display device provided in the slot machine of the embodiment, according to the present invention.

FIG. 18 is a view showing a flowchart of the main control process for the slot machine according to the embodiment of the present invention.

FIG. 19 is a view showing a flowchart of the coin-insertion/start-check process for the slot machine according to the embodiment of the present invention.

FIG. 20 shows a flowchart of the symbol random-determination process for the slot machine according to the embodiment of the present invention.

FIG. 21 shows a flowchart of the symbol display control process for the slot machine according to the embodiment of the present invention.

FIG. 22 shows a flowchart of the number-of-payouts determination process for the slot machine according to the embodiment of the present invention.

FIG. 23 shows a flowchart of a feature game process for the slot machine of the embodiment, according to the present invention.

FIG. 24 shows a flowchart of the bonus symbol determination process for the slot machine of the embodiment, according to the present invention.

FIG. 25 is an explanatory diagram showing an overview of the slot machine of the embodiment, according to the present invention.

FIG. 26 shows a flowchart of the bonus symbol determination process for the slot machine of the embodiment, according to the present invention.

### DESCRIPTION OF THE PREFERRED EMBODIMENTS

### Outline of Embodiment

The following will describe an embodiment of the present invention with reference to the figures.

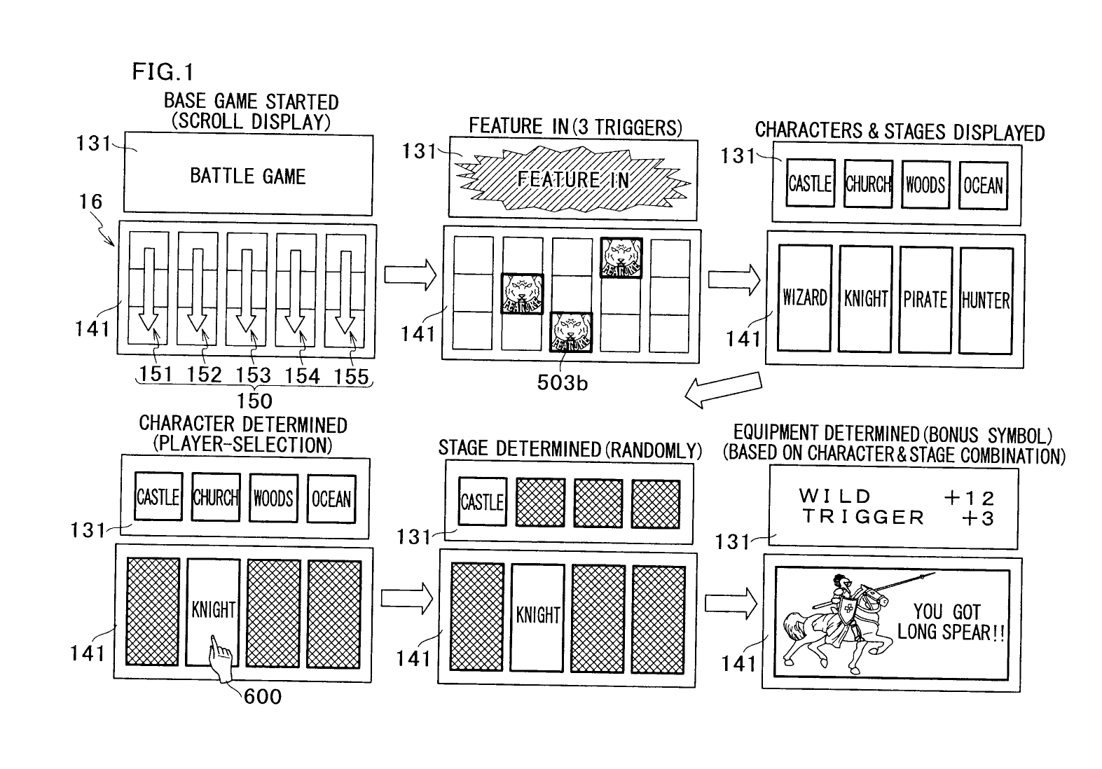

As shown in FIG. 1, a slot machine 10 of an embodiment of the present invention executes a playing method including the steps of:

running a base game capable of awarding a payout according to a predetermined combination of symbols;

when three feature symbols 503b are rearranged in the base game, shifting the gaming mode to a feature game which is more advantageous for a player than the base game;

receiving an operation of by the player;

determining one of a plurality of character settings for effects of the game, based on the operation by the player;

randomly determining one of a plurality of stage settings for effects of the game;

determining random determination odds based on a combination of the character setting determined and the stage setting determined;

based on the random determination odds, randomly determining one of a plurality of advantageous conditions relative to an advantage level of the player in the feature game; and

running a feature game based on the advantageous condition thus determined.

Here, the “base game” of the present embodiment is so-called slot game in which a game is started on premise that a predetermined amount of bet is placed by using a game medium such as a coin, and a plurality of video reels 151 to 155 displayed on a lower image display panel 141 of a symbol display device 16 starts to scroll and then stops scrolling after a predetermined period. Then, a payout is awarded based on the combination of symbols 501 stop-displayed on the surface of the video reels 151 to 155.

Further, the “feature game” of the present embodiment refers to a so-called free game in which a game is started without use of a game medium such as a coin. In the feature game, the plurality of video reels 151 to 155 displayed on the lower image display panel 141 of the symbol display device 16 starts to scroll and stops after a predetermined period, as is the case of the base game. Then, a higher payout than the payout of the base game may be awarded based on a combination of the symbols 501 stop-displayed on the surface of the video reels 151 to 155. The feature game is run on condition that a predetermined number (e.g. three) or more of feature symbols 503b are arranged on a not-shown payline L in the base game. Further, shifting from the base game to the feature game is referred to as “feature IN”. Note that the feature game may be any type of game, as long as it is more advantageous than the base game. Another feature game may be adopted in combination, provided that the player is given a more advantageous playing conditions than the base game. For example, the feature game may be a game that provides a player with a chance of winning more game values than the base game or a game that provides a player with a higher chance of winning game values than the base game. Alternatively, the feature game may be a game that consumes fewer amounts of game values than the base game. In the feature game, these games may be provided alone or in combination.

The “free game” is a game runnable with a bet of less game value than the base game. Note that “bet of less game value” encompasses a bet of zero game value. The “free game” therefore may be a game runnable without a bet of game value, which awards an amount of game value based on symbols 501 rearranged. In other words, the “free game” may be a game which is started without the premise that a game value is consumed.

The expression “rearrange” means dismissing an arrangement of symbols 501, and once again arranging symbols 501. “Arrangement” in this specification means a state of symbols 501, which can be visibly confirmed by a player.

The symbols 501 include “bonus symbols 503” and “ordinary symbols 502.”

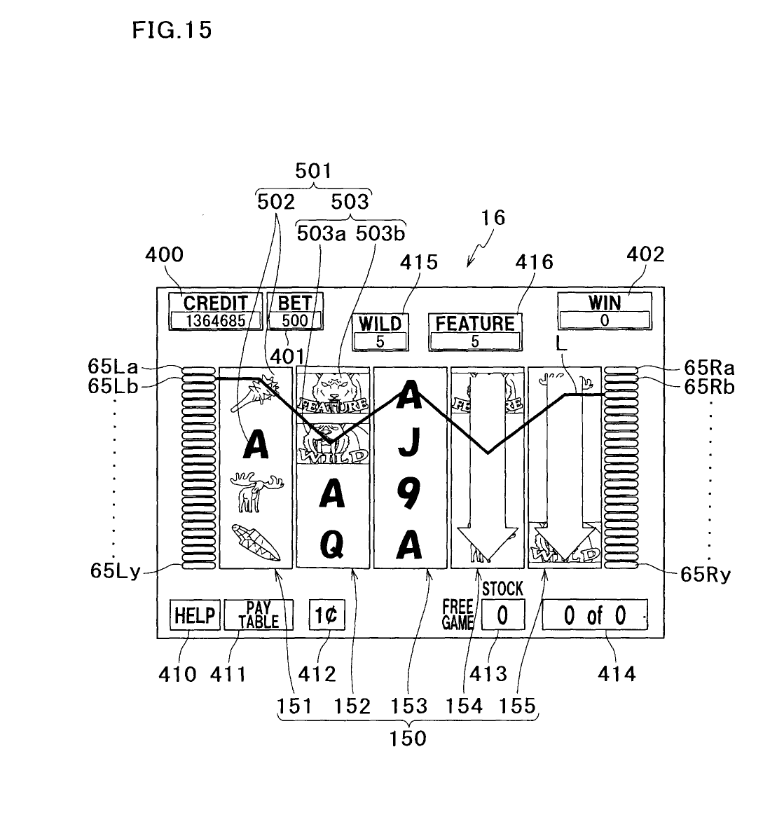

That is, the “symbols 501” is a superordinate conception of the bonus symbols 503 and ordinary symbols 502. The bonus symbols 503 include wild symbols 503a and feature symbols 503b, as shown in FIG. 15. The wild symbol 503a is a symbol substitutable for any type of symbols 501. Each feature symbols 503b is a symbol serving as a trigger for starting at least a feature game. That is, the feature symbol 503b triggers transition from the base game to the feature game, and triggers increases in the number of bonus symbols 503 after the start of the feature game. Further, the feature symbol 503b triggers increases in the number of bonus symbols 503 in the feature game, that is, the feature symbol 503b triggers increases in the number of feature symbols 503b and/or wild symbols 503a. Note that the feature symbol 503b may trigger an increase in the number of repetitions of game (hereinafter simply referred to as “game repetition count”) in the feature game.

The “character settings” are each a setting of a character for an effect of the feature game. In the present embodiment, there are four characters: wizard, knight, pirate, and hunter. The type and the number of characters in the present invention are not limited to these. Further, the present embodiment deals with a structure that enables the player to select the character setting by pressing a later-described selection button 500 to operate a character selection cursor 600.

The “stage settings” are each a setting of a stage for an effect of the feature game. In the present embodiment, there are four types of stages: castle, church, woods, and ocean. However, the type and the number of stages in the present invention is not limited to this. Further, the present embodiment deals with a structure that automatically performs random determination of the stage setting after the player selects the character setting.

The “advantageous condition” is the number of bonus symbols 503 (wild symbols 503a, feature symbols 503b) that replace the symbols 501 on the video reels 151 to 155 in the base game, when shifting the game mode from the base game to the feature game. That is, greater the number of bonus symbols 503 in the feature game, the more advantageously the player is able to play the feature game.

In the present embodiment, the “random determination odds” are the odds relating to random determination of the advantageous condition in the feature game, which is an amount of increase in the number of the bonus symbols 503. In the present embodiment, the random determination odds are variable, based on a combination of the character setting determined and the stage setting determined.

For example, as shown in FIG. 1, when the base game starts, the video reels 151 to 155 on the lower image display panel 141 of the symbol display device 16 rotate to rearrange the symbols 501. At this time, if three or more feature symbols 503b are arranged, the feature IN occurs, and the occurrence of the same is displayed on the upper image display panel 131.

When the feature IN occurs, a character setting image is displayed on the upper image display panel 131. Further, at the same time, a stage setting image is displayed on the lower image display panel 141. Thus, the player is able to visually grasp the character and the stage of the feature game.

When the character setting image and the stage setting image are displayed, the character selection cursor 600 is displayed on the lower image display panel 141. The player is able to move this character selection cursor 600 horizontally by pressing the later-described selection button 500. Doing so enables the player to select a desirable character out of the plurality of characters.

When the player selects a character, one of the stages is randomly determined.

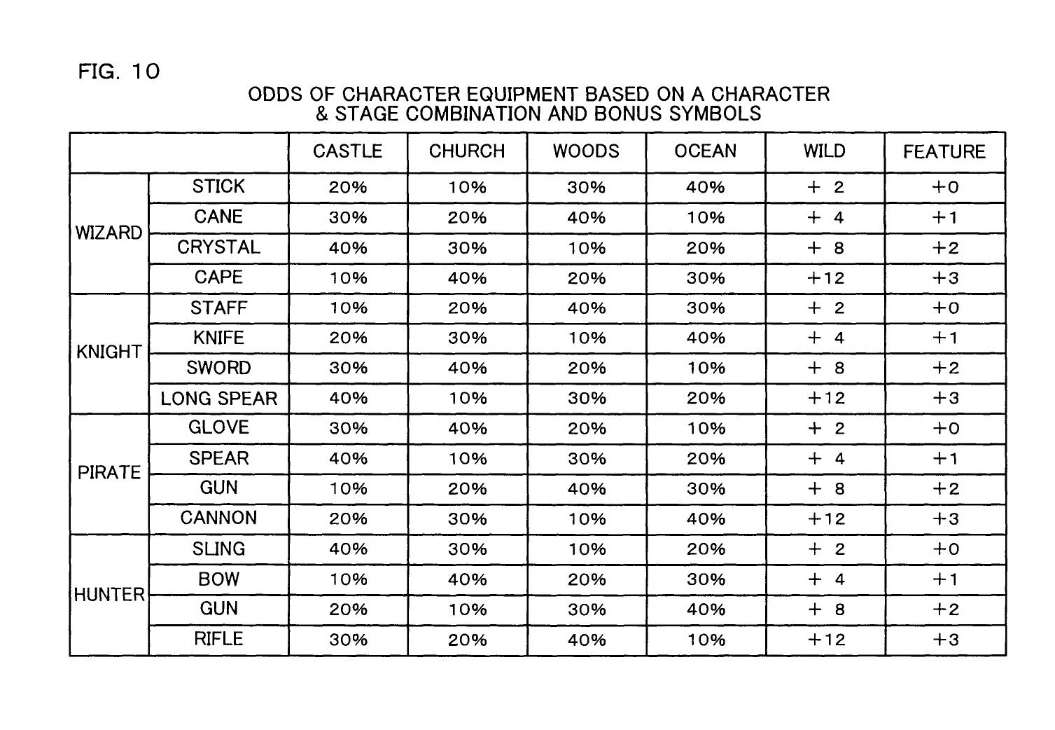

When the character setting and the stage setting are determined, the random determination odds are determined based on the combination of the character setting and the stage setting. Based on the random determination odds thus determined, the equipment of the character is randomly determined. The type of equipment of the character is associated with the type of the bonus symbols 503 and an amount of increase in the number of the bonus symbols 503 in the feature game, as shown in FIG. 10. That is, the randomly determined equipment determines the advantageous condition of the feature game. For example in FIG. 1, the player has selected “knight” as the character setting, and the stage setting determined is “castle”. Based on this combination of the “knight” and “castle” thus determined, the random determination odds are determined, and the long spear is determined as the equipment through a random determination based on the random determination odds. At this time, the lower image display panel 141 displays an image of a knight equipped with a long spear. Further, the upper image display panel 131 displaying an image indicating the additional bonus symbols 503 (twelve additional wild symbols 503a and three additional feature symbols 503b) with which the long spear as the equipment is associated. Then, the feature game is run with an increased number of bonus symbols 503.

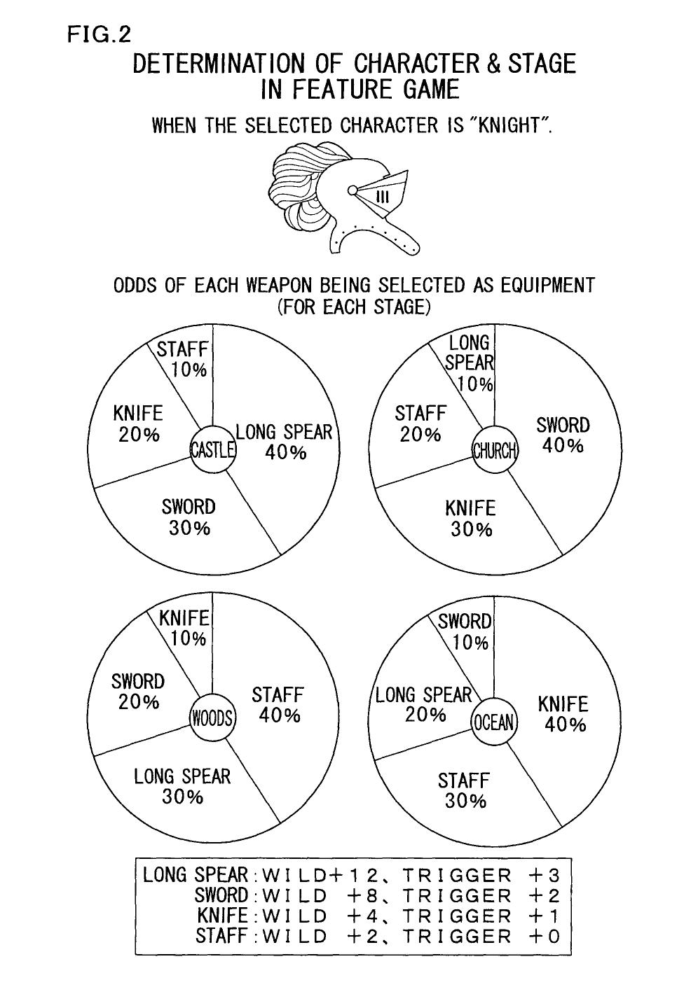

FIG. 2 shows the random determination odds of the item to be equipped in each stage setting, when the character setting is “knight”. As shown in FIG. 2, for example, where the stage setting is “castle”, the random determination odds of the items are: 40% for “long spear”, 30% for “sword”, 20% for “knife”, and 10% for “staff”. On the other hand, where the stage settings is “church”, the random determination odds of the items are: 40% for “sword”, 30% for “knife”, 20% for “staff”, and 10% for “long spear”. As is understood from this, the random determination odds for items are varied, based on a combination of the character setting and the stage setting. Further, as shown in FIG. 2, the number of additional bonus symbols 503 in the feature game is determined based on the item determined. For example, when the “long spear” is the item to be equipped, the bonus symbols 503 to be added in the feature game are twelve wild symbols 503a and three feature symbols 503b.

As described, when a predetermined condition is met in the base game, the character setting is determined based on an operation of the selection button 500 by the player, and the stage setting is randomly determined. Based on a combination of the character setting and the stage setting, the random determination odds are determined, and the advantageous condition in the feature game is determined based on the random determination odds. Based on the advantageous condition thus determined, the feature game is run. As is understood from this, the random determination odds for determining the advantageous condition of the feature game are varied, based on a combination of the character setting selected by the player and the stage setting which is randomly determined. This structure allows wider variation of the advantageous conditions to be determined, than a structure that determines the advantageous condition when the player selects the character setting. Thus, there is provided a slot machine 10 having an improved entertainment characteristic.

Further, as mentioned above, the advantageous condition determined is reported to the player via the upper image display panel 131 and the lower image display panel 141. This may enable the player to grasp the level of the advantageous condition by effects such as displaying an image of a character with a stronger item or outputting a larger sound from a later-described speaker 112 for a better advantageous condition. Thus, there is provided a slot machine 10 having an improved entertainment characteristic.

Further, as is already described, the lower image display panel 141 displays the character according to the character setting determined. Further, the lower image display panel 141 displays the item of the character, according to the advantageous condition determined. This may enable the player to grasp the level of the advantageous condition by effects such as displaying an image of a character with a stronger item for a better advantageous condition. Thus, there is provided a slot machine 10 having an improved entertainment characteristic.

(Function Flow of Slot Machine)

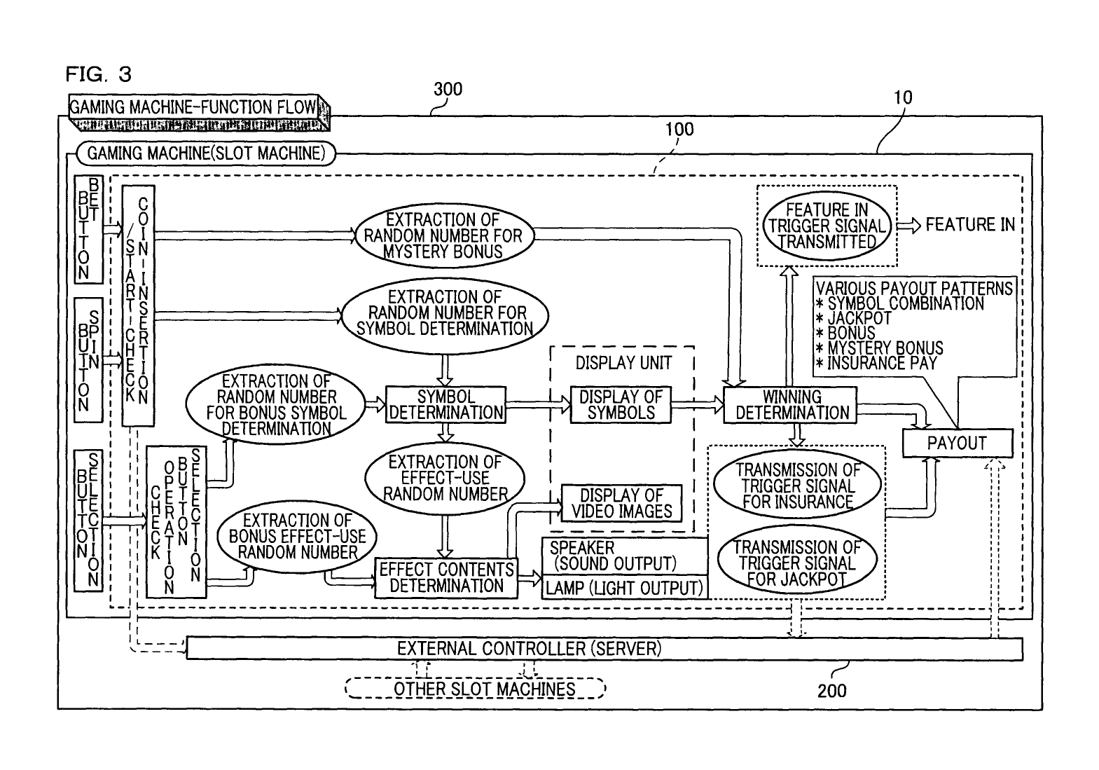

With reference to FIG. 3, basic functions of the slot machine 10 of the present embodiment are described.

As shown in FIG. 3, the slot machine 10 is connected and in communication with an external controller (server) 200 along with a plurality of other slot machines 10. Each of the slot machines 10 has therein a game controller 100. The game controller 100 controls various functional parts and runs various games.

<Coin-Insertion/Start-Check>

First, the slot machine 10 checks if any bet button (1-bet button 34, maximum bet button 35) is pressed by a player. Then, the slot machine 10 checks whether a spin button 31 is pressed by the player.

<Symbol Determination>

Next, when the player presses the spin button unit 31, the slot machine 10 extracts a random number for symbol determination. Then, for each video reel (151 to 155) displayed on the display unit, the slot machine 10 determines symbols 501 to be presented to the player when scrolling of symbol columns is stopped. Note that the display unit corresponds to the upper image display panel 131 and the lower image display panel 141.

<Symbol Display>

Next, the slot machine 10 starts scrolling a symbol column of each video reel (151 to 155), and stops the scroll so that the symbols 501 determined are displayed on the display unit.

<Winning Determination>

Next, when the symbol column of each video reel (151 to 155) stops scrolling, the slot machine 10 determines whether a combination of the symbols 501 displayed on the display unit relates to a winning.

<Payout>

Next, when a combination of the symbols 501 displayed on the display unit yields a winning, the slot machine 10 awards the player a benefit according to the combination of the symbols 501.

For example, when a combination of symbols 501 which relates to a payout of one or more coins, the slot machine 10 pays out the number of coins to the player according to the combination of symbols 501.

When a combination of symbols 501 related to a jackpot trigger is displayed, the slot machine 10 pays out coins in an amount of jackpot to the player. A jackpot is a function of partially accumulating coins consumed by a player of each slot machine 10 as a jackpot prize, and when the jackpot trigger is established in a slot machine 10, awarding the jackpot prize through that slot machine 10.

In each game, the slot machine 10 calculates the amount (accumulation amount) to be accumulated to the amount of jackpot and transmits to an external controller 200. The external controller 200 adds to the jackpot prize the accumulation amount received from each slot machine 10.

Further, in addition to the aforementioned benefits, the slot machine 10 is provided with benefits such as a mystery bonus and insurance.

Mystery bonus is a predetermined amount of payout awarded to a randomly selected winner. When the spin button 31 is pressed, the slot machine 10 samples a random number for mystery bonus and randomly determines if mystery bonus is established.

Insurance is a function provided for the purpose of salvaging a player when the feature game is not run for a long period of time. In the present embodiment, the activation of the insurance is selectable by a player. Making insurance effective requires a predetermined insurance-purchase amount to be paid in exchange.

In the case where the insurance has been made effective, the slot machine 10 starts counting the number of games. Then, when the counted number of games played reaches a predetermined number without any award of a large amount of game media from a feature game or the like, the slot machine 10 awards an amount of game media set as the insurance.

Further, when a combination of feature symbols 503b displayed relates to the feature game trigger, the so-called feature IN occurs and the slot machine 10 starts the feature game. It is to be noted that, in the present embodiment, a game (free game) in which the random determination of to-be-stopped symbols 501 is held a predetermined number of times without using coins is played as a feature game.

<Selection Button Operation Check>

When the feature IN occurs, the slot machine 10 determines whether or not the selection button 500 has been pressed by the player to select a character. If a character has been selected by the player, the slot machine 10 randomly determines the stage. Then, the slot machine 10 samples a random number for determining bonus symbols to determine the bonus symbols 503 as the benefit of the feature game.

<Determination of Effects>

Further, when the character setting and the stage setting for the feature game are determined, the slot machine 10 samples a bonus effect-use random number to determine the contents of effect provided through the display unit, lamp 111, and speaker 112.

The slot machine 10 produces effects by displaying images on the display unit, outputting the light from lamps 111, and outputting sounds from speakers 112. The slot machine 10 extracts a random number for effect and determines contents of the effects based on the symbols 501 and the like randomly determined.

(Overview of Gaming System)

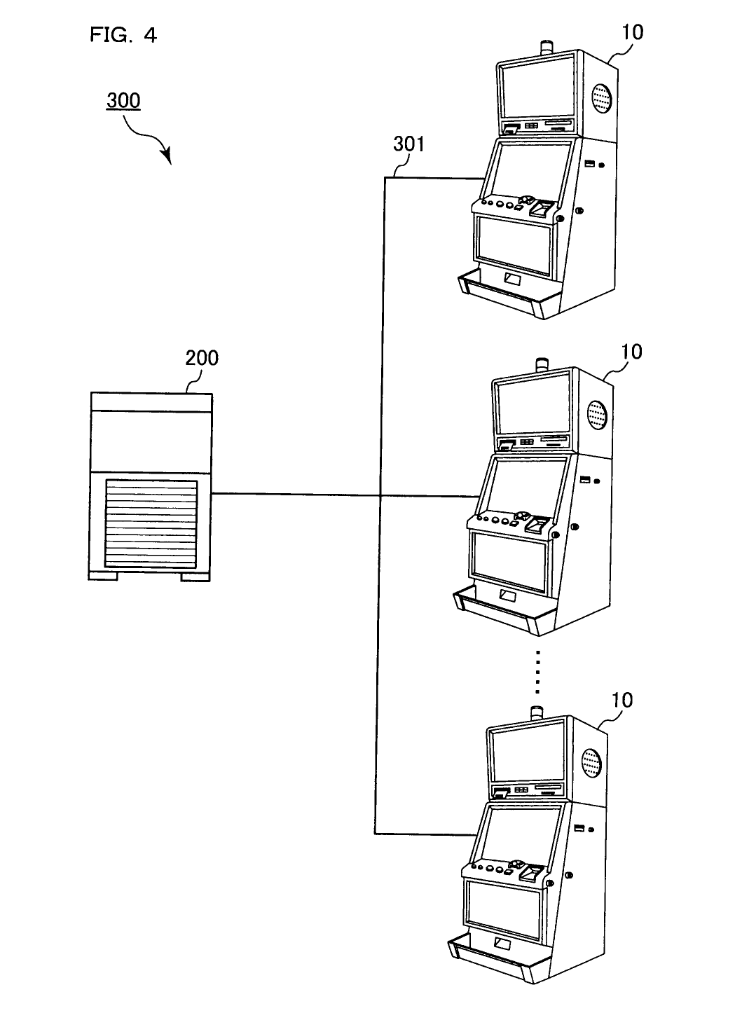

The basic functions of the slot machine 10 have been described above. Next, the following describes a gaming system 300 including the slot machine 10, with reference to FIG. 4.

The gaming system 300 includes a plurality of slot machines 10, and an external controller (server) 200 that is connected to each of the slot machines 10 through a communication line 301.

The external controller 200 is for controlling the slot machines 10. In the present embodiment, the external controller 200 is a so-called hall server provided in a gaming facility having the slot machines 10. Each slot machine 10 is given a unique identification number. The external controller 200 identifies the source of data from any of the slot machines 10, by referring to this identification number. The identification number is also used for designating the transmission destination, when transmitting data from the external controller 200 to any slot machine 10.

It is to be noted that the gaming system 300 may be constructed within a single game facility where various games can be conducted, such as a casino, or may be constructed among a plurality of gaming facilities. Further, when building the gaming system 300 in a single gaming facility, the gaming system 300 may be built in each floor or each section of the gaming facility. The communication line 301 may be a wired or wireless line, and may be a dedicated line, an exchange line, or the like.

(Mechanical Structure of Slot Machine)

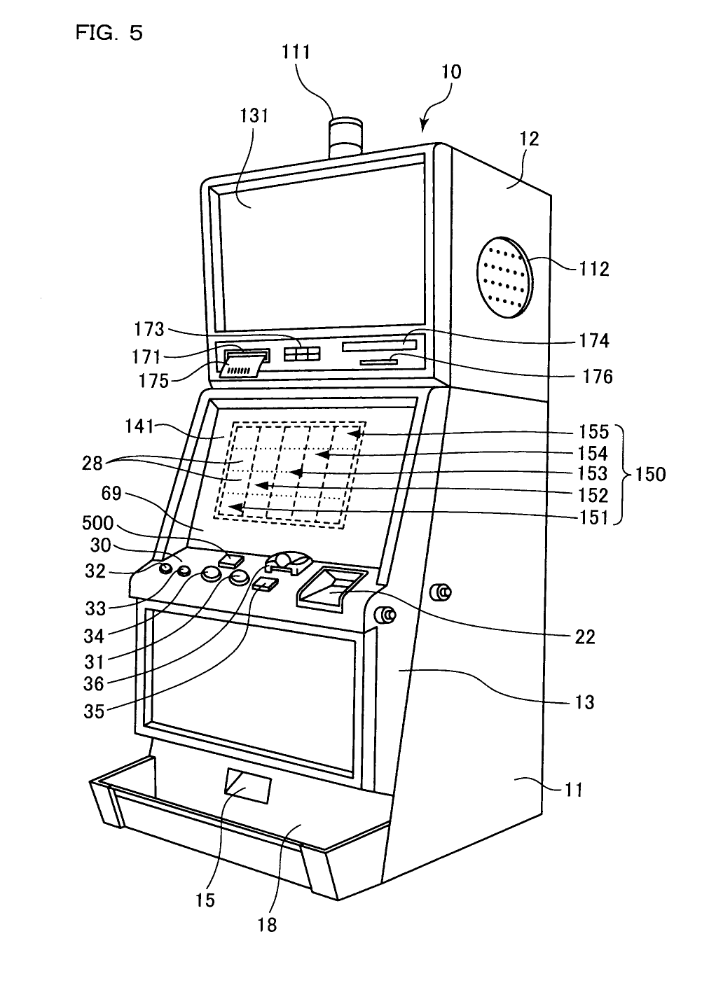

Now, the overall configuration of the slot machine 10 will be described with reference to FIG. 5.

A coin, a bill, or electronic information equivalent to these is used as a game medium in the slot machine 10.

The slot machine 10 includes: a cabinet 11, a top box 12 provided above the cabinet 11, and a main door 13 provided on the front surface of the cabinet 11.

The main door 13 has a lower image display panel 141 provided to the symbol display device 16. The lower image display panel 141 is formed of a transparent liquid crystal panel. A screen displayed on the lower image display panel 141 has a display window 150 at its center. The display window 150 includes twenty display blocks 28 which are arranged in five columns and four rows. The columns form video reels 151 to 155, each having four display blocks 28. The four display blocks 28 in each of the video reels 151 to 155 are displayed as if all the display blocks 28 are moving downward at various speed. This enables rearrangement, in a manner that symbols 501 respectively displayed in the display blocks 28 are rotated in a longitudinal direction and stopped thereafter.

As shown in FIG. 15, on the left and right sides of the display window 150, symmetrically-arranged payline occurrence columns are respectively disposed. A payline occurrence column on the left when viewed from the front side includes 25 payline occurrence parts 65L (65La to 65Ly).

On the other hand, a payline occurrence column on the right when viewed from the front side includes 25 payline occurrence parts 65R (65Ra to 65Ry).

Each payline occurrence part 65L is paired with one of the payline occurrence parts 65R. Paylines L are prescribed, each extending from one of the payline occurrence parts 65L to one of the payline occurrence parts 65R which are paired with each other. Although there are 25 paylines L in the present embodiment, FIG. 15 only shows one payline L for the sake of easier understanding.

Each payline L is activated when the payline L connects a pair of payline occurrence parts 65L and 65R. The payline otherwise is inactive. The number of active paylines L is determined based on a bet amount. When the bet amount is the maximum, the maximum number of paylines L (i.e. 25 paylines L) are activated. Each active payline L forms various winning combinations of symbols 501. The winning combination is detailed later.

Further, as shown in FIG. 1, the lower image display panel 141 displays a character setting image and an image of the selected character equipped with a randomly determined item.

The present embodiment deals with a case where the slot machine 10 is a video slot machine. However, the slot machine 10 of the present invention may partially adopt a mechanical reel in place of the video reels 151 to 155.

Further, a not-shown touch panel 69 is disposed at the front of the lower image display panel 141, and a player is able to input various instructions by operating the touch panel 69. From the touch panel 69, an input signal is transmitted to the main CPU 71.

Below the lower image display panel 141 are control panel 30, a coin receiving port 36, and a bill validator 22. The control panel 20 includes plural buttons by which a player is able to input an instruction related to progression of a game. The coin receiving port 36 receives a coin and takes it into the cabinet 11.

The control panel 30 has: a spin button 31, a change button 32, a cashout button 33, a 1-bet button 34, a maximum bet button 35, and a selection button 500.

The spin button 31 is for inputting an instruction to start scrolling symbols 501. A change button 32 is used when requesting a gaming facility staff member to exchange money. The cashout button 33 is for inputting an instruction to pay out credited coins to a coin tray 18.

The 1-bet button 34 is for inputting an instruction to bet a single coin out of the credited coins. The maximum bet button 35 is for inputting an instruction to bet the maximum number of coins bettable in one game (500 coins in this embodiment), out of the credited coins.

The bill validator 22 is for validating the legitimacy of a bill input, and takes into the cabinet 11 a bill recognized as legitimate. It is to be noted that the bill validator 22 may be configured so as to be capable of reading a later-described ticket 175 with a barcode.

On a lower front surface of the main door 13, that is, below the control panel 30, a belly glass 132 on which a character of the slot machine 10 or the like is drawn is provided and a coin outlet port 15 and a coin tray 18 are provided below the belly glass. The coin outlet port 15 is a path for paying out coins to from inside the cabinet 11 to the coin tray 18. The coin tray 18 retains coins paid out from the coin outlet port 15.

An upper image display panel 131 is provided at the front face of the top box 12. The upper image display panel 131 has a liquid crystal panel, and displays thereon an image which provides introduction to the game, the rules of the game, or the like.

Further, the upper image display panel 131 displays a stage setting image and an image indicative of an increase in the number of bonus symbols 503 in the feature game, as shown in FIG. 1.

Further, the top box 12 is provided with speakers 112. The speaker 112 outputs sound to provide effects to various games. Further, the speaker 112 outputs a sound to notify the player of the corresponding to a randomly determined amount of increase in the number of bonus symbols 503 in the feature game. For example, the speaker 112 may output a larger sound or a happier sound for a larger amount of increase in the number of the bonus symbols 503.

Further, the top box 12 is provided with a lamp 111. The lamp 111 outputs light to provide effects to various games. Further, for the purpose of notifying the player, the lamp 111 outputs light corresponding to a randomly determined amount of increase in the number of bonus symbols 503 in the feature game. For example, the lamp 111 outputs brighter light or light or a bright color for a larger amount of increase in the number of the bonus symbols 503.

A ticket printer 171, a card reader 176, a data display 174, and a keypad 173 are provided on the lower side of the upper image display panel 131.

The ticket printer 171 prints on a ticket a barcode representing encoded data of the number of credits, date, the identification number of the slot machine 10, and the like, and outputs the ticket as the ticket 175 with a barcode. A player is able to exchange the barcoded ticket 175 with bill or the like at a predetermined location in the gaming facility (e.g. change booth of a casino).

The card reader 176 reads/writes data from /into a smart card. The smart card is carried by a player, and stores therein data for identifying the player, data relating to a history of games played by the player, or the like. The smart card may store data of coins, bill, or a credit card. Further, it is possible to adopt a magnet stripe card instead of the smart card. The data display 174 includes a fluorescent display or the like, and displays the data read by the card reader 176 and the data input by the player through the keypad 173. The keypad 173 is for inputting a command and data related to ticket issuance or the like.

The data display 174 includes a fluorescent display, LEDs and the like, and displays the data read from the smart card or the data inputted by the player via the keypad 173, for example. The keypad 173 is for inputting data.

(Electrical Structure of Slot Machine)

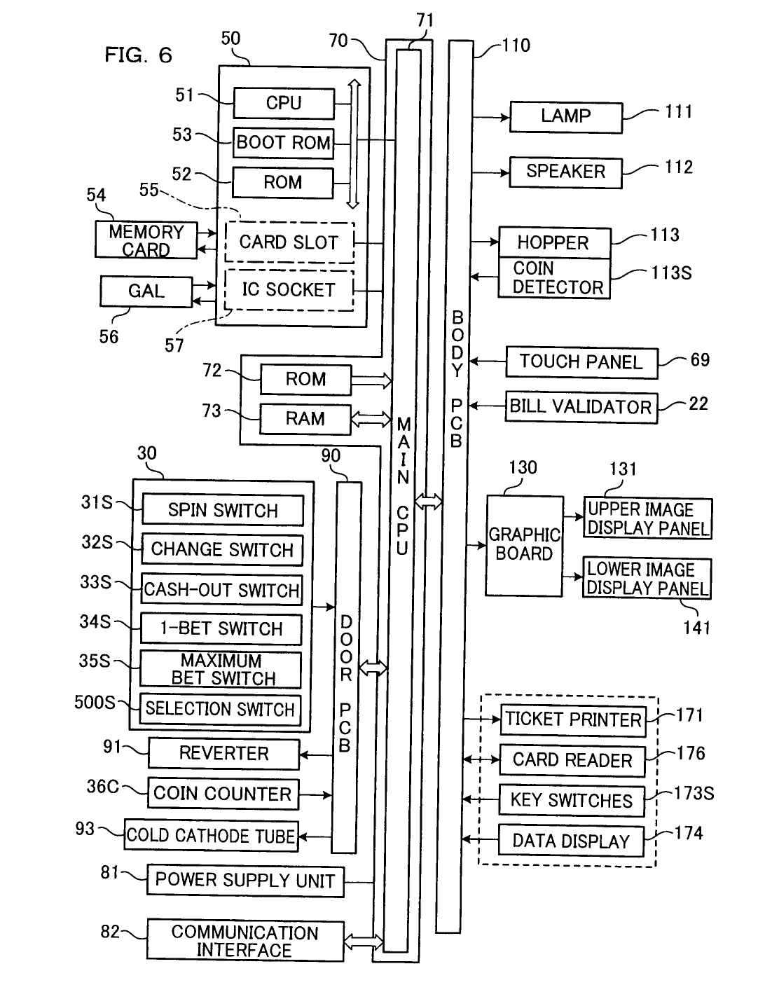

Next, with reference to FIG. 6, a configuration of a circuit included in the slot machine 10 is described.

FIG. 6 shows an internal structure of the slot machine 10, that is, FIG. 6 is a block diagram of the game controller 100. The gaming board 50 is provided with a CPU (Central Processing Unit) 51, a ROM 55, a ROM (Read Only Memory) 52, a boot ROM 53, a card slot 55 corresponding to a memory card 54, and an IC socket 57 corresponding to a GAL (Generic Array Logic) 56. These members are connected to one another through an internal bus.

The memory card 54 includes an involatile memory such as compact flash®, and stores a game program and a gaming system program. The game program includes a program related to game progression and a program for producing effects by images and sounds. The game program includes a symbol determination program The symbol determination program is a program for determining symbols 501 to be rearranged on the display blocks 28.

Further, the card slot 55 is configured so that the memory card 54 can be inserted thereinto and removed therefrom, and is connected to a motherboard 70 by an IDE bus. Thus, the type and content of a game run by a slot machine 10 can be modified by detaching the memory card 54 from the card slot 55, write a different game program into the memory card 54, and inserting the memory card 54 back into the card slot 55.

The GAL 56 is a type of PLD (Programmable Logic device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like.

The authentication program is a program (falsification check program) for authenticating the game program and the gaming system program. The pre-authentication program is a program for authenticating the aforementioned authentication program. The authentication program and the pre-authentication program are written along a procedure (authentication procedure) for proving that the program to be the subject has not been tampered.

The motherboard 70 is structured by using a marketed general-purpose motherboard (printed circuit board mounted thereon basic components of a personal computer), and includes: a main CPU 71; a ROM 72; a RAM (Random Access Memory) 73; and a communication interface 82. Note that the motherboard 70 corresponds to the game controller 100 in the present embodiment.

The ROM 72 is made of a memory device such as a flash memory, and stores permanent data and a program such as BIOS (Basic Input/Output System) which is run by the main CPU 71. When the BIOS is executed by the main CPU 71, a process for initializing predetermined peripheral devices is conducted. Further, through the gaming board 50, process of loading the game program and the gaming system program stored in the memory card 54 is started. Note that, in the present invention, the ROM 72 may be rewritable or non-rewritable.

The RAM 73 stores data used during operation of the main CPU 71 and a program such as a symbol determination program. For example, when the process of loading the aforementioned game program, gaming system program or authentication program is conducted, the RAM 73 can store the program. The RAM 73 is provided with working areas used for operations in execution of these programs. Examples of the areas include: an area that stores counters for managing the number of games, the number of bets, the payout amount, the credit amount and the like; and an area that stores symbols (code numbers) determined randomly.

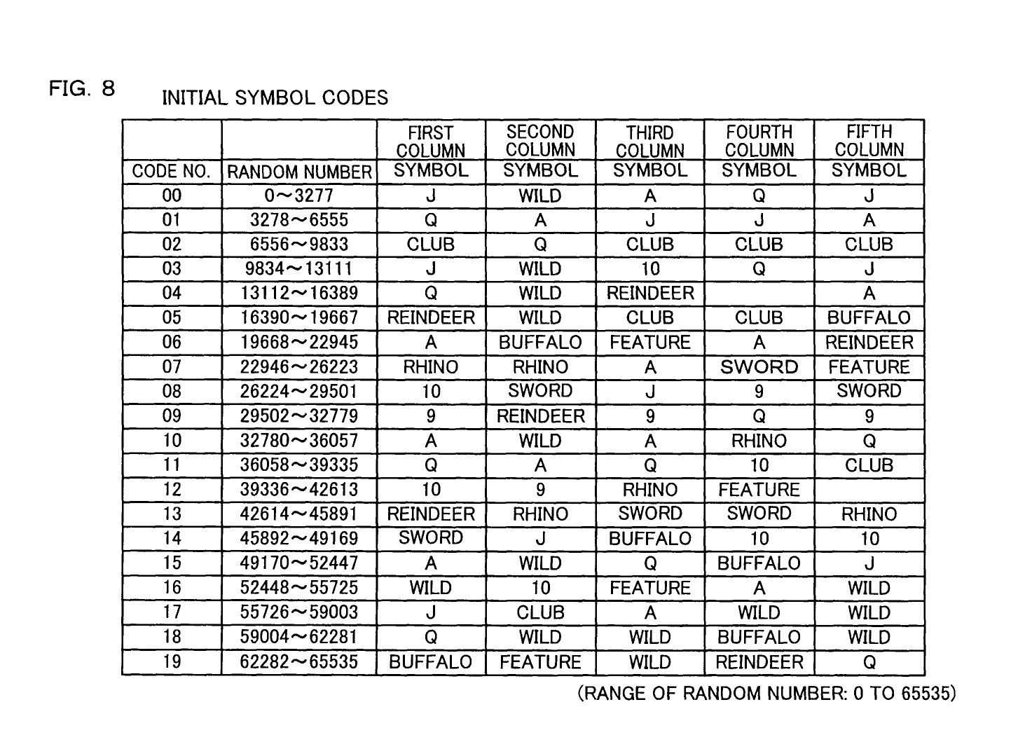

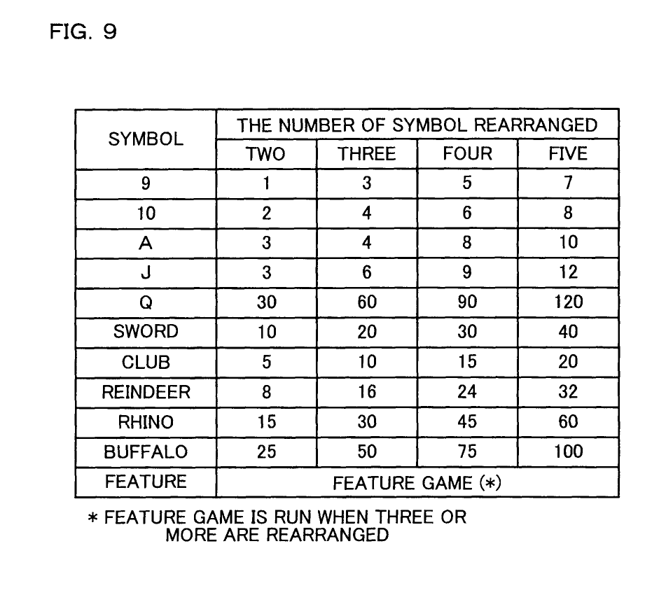

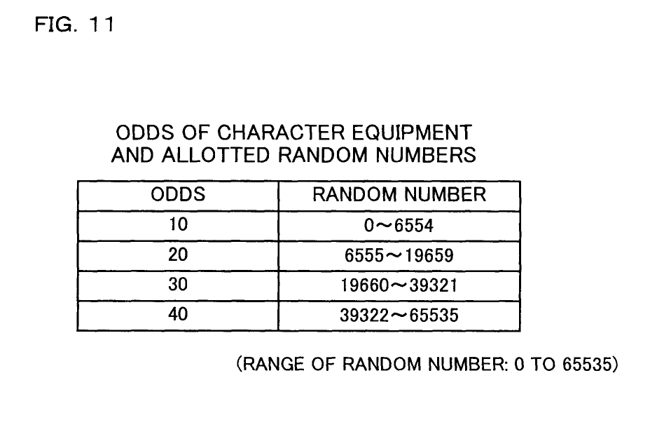

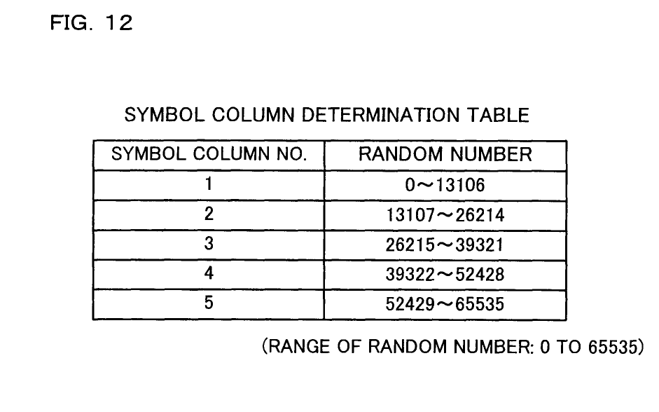

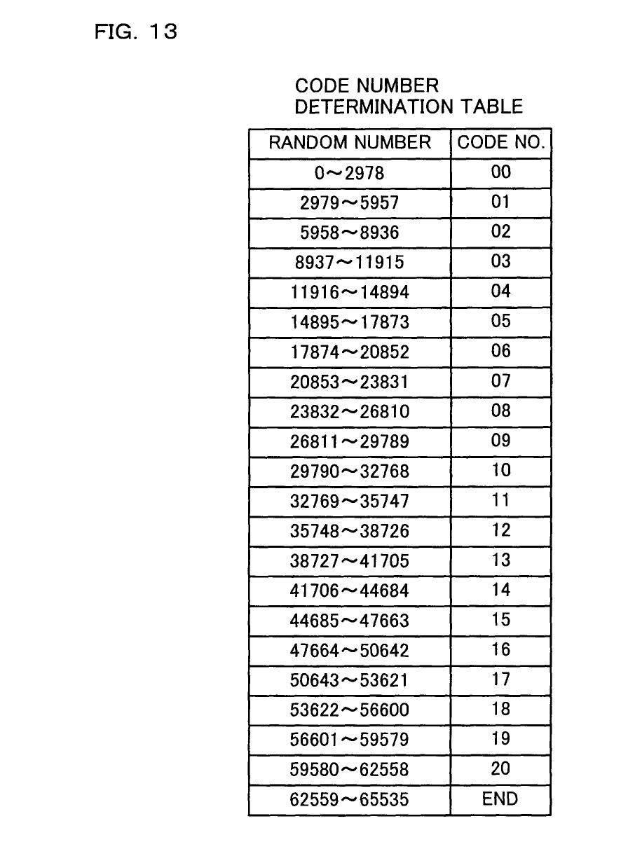

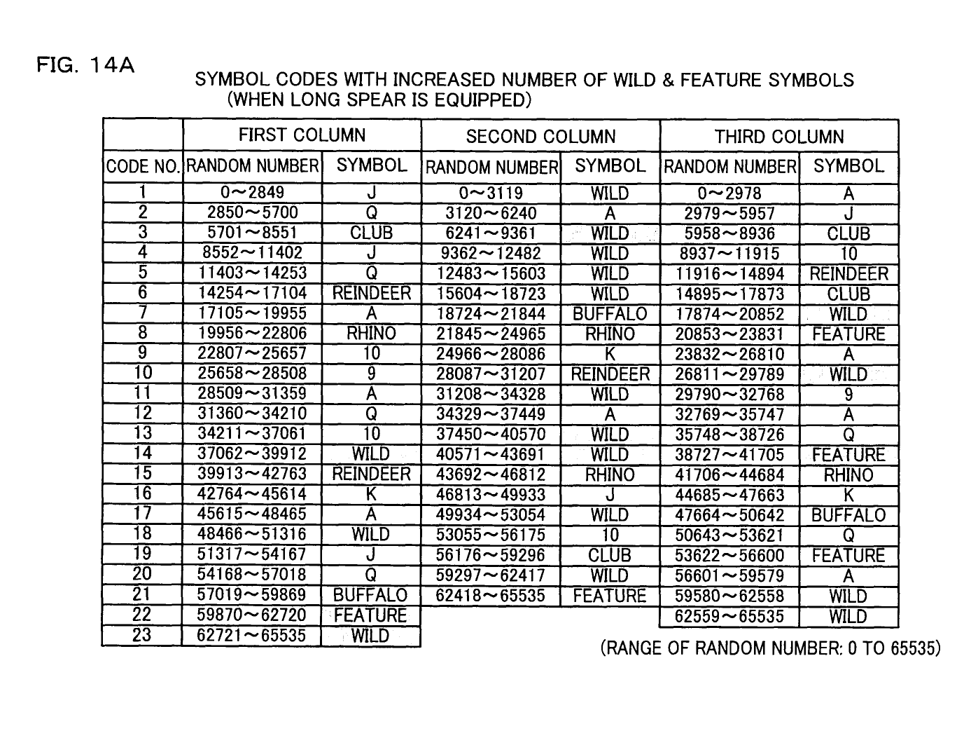

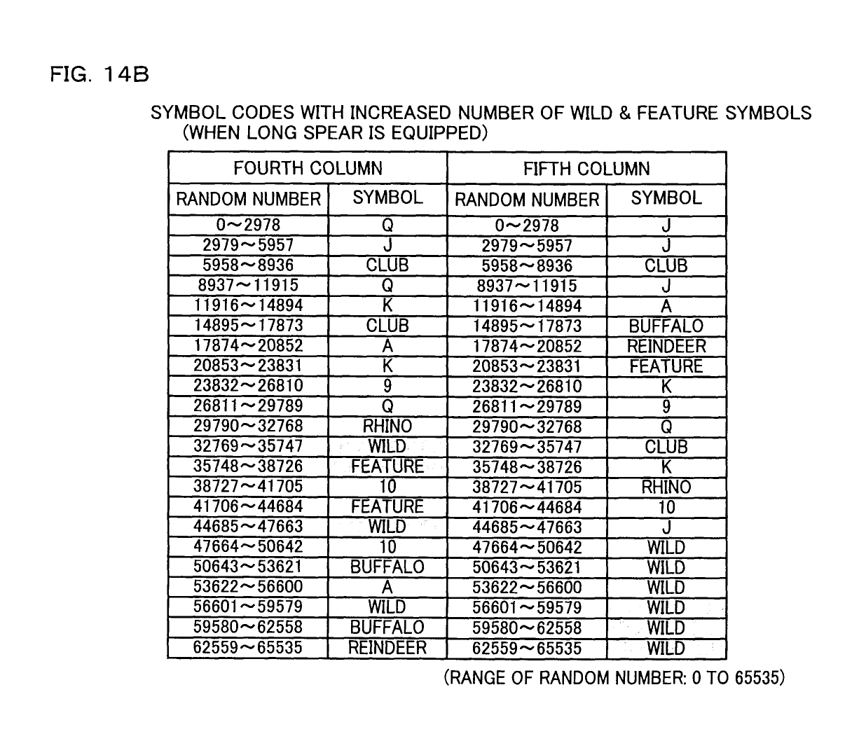

Further, the RAM 73 stores: base game symbol table data indicating a base game symbol table (see FIG. 8), payout table data indicating a payout table (see FIG. 9), corresponding bonus symbol table data indicating a corresponding bonus symbol table (see FIG. 10), corresponding random number table data indicating a corresponding random number table (see FIG. 11), symbol column determination table data indicating a symbol column determination table(see FIG. 12), code number determination table data indicating a code number determination table (see FIG. 13), feature game symbol table data indicating a feature game symbol table (see FIGS. 14A and 14B), or the like. The base game symbol table and the feature game symbol table each includes a list of symbols 501 of the symbol columns of the display blocks 28, and associated code numbers and random numbers. The payout table includes a list of types and counts of the symbols 501 rearranged on a payline L, and corresponding amounts of payouts. The corresponding bonus symbol table indicates the random determination odds of the character equipment based on character and stage combinations, and corresponding amounts of increase in the number of bonus symbols 503. The corresponding random number table indicates the random determination odds of the character equipment and corresponding random numbers. The various pieces of table data may be included in the game program stored in the memory card 54.

The communication interface 82 is for communicating with the external controller 200 such as a server, through the communication line 301. Further, the motherboard 70 is connected with a later-described door PCB (Printed circuit Board) 90 and a body PCB 110 by respective USBs. The motherboard 70 is also connected with a power supply unit 81.

When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices which operates under control of the main CPU 71.

The door PCB 90 is connected with a control panel 30, a reverter 91, a coin counter 36C and a cold cathode tube 93.

The control panel 30 is provided with a spin switch 31S corresponding to the spin button 31, a change switch 32S corresponding to the change button 32, a cashout switch 33S corresponding to a cashout button 33, 1-bet switch 34S corresponding to the 1-bet button 34, a maximum bet switch 35S corresponding to the maximum bet button 35, and a selection switch 500S corresponding to the selection button 500. Each of the switches 31S to 35S and 500S outputs an input signal to the main CPU 71 when corresponding one of the buttons 31 to 35 and 500 is operated by the player.

The coin counter 36C is provided inside the coin receiving port 36, and validates whether a coin input by a player to the coin receiving port 36 is a legitimate coin. Any non-legitimate coin is output from the coin outlet port 15. Further, the coin counter 36C, when detecting a legitimate coin, outputs an input signal to the main CPU 71.

The reverter 91 operates based on a control signal outputted from the main CPU 71, and distributes valid coins validated by the coin counter 36C into a hopper 113 or a cash box (not shown). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal outputted from the main CPU 71.

The body PCB 110 is connected with the lamp 111, the speaker 112, the hopper 113, a coin detector 113S the touch panel 69, the bill validator 22, the ticket printer 171, the card reader 172, a key switch 173S and the data display 174.

The lamp 111 flashes based on a control signal output from the main CPU 71. The speaker 112 outputs sounds such as BGM, based on a control signal outputted from the main CPU 71.

The hopper 113 operates based on a control signal outputted from the main CPU 71, and pays out coins of the specified number of payouts from the coin outlet port 15 to the coin tray 18. The coin detector 113S outputs a signal to the main CPU 71 upon detection of coins paid out by the hopper 113.

The bill validator 22 validates whether a bill is legitimate, and only receives a legitimate bill into the cabinet 11. The bill validator 22, when receiving a legitimate bill, outputs an input signal indicating the value of the bill to the main CPU 71. The main CPU 71 stores in the RAM 73 a credit amount corresponding to the value of the bill indicated by the input signal.

Based on a control signal outputted from the main CPU 71, the ticket printer 171 prints on a ticket a barcode representing encoded data of the number of credits stored in the RAM 73, date, the identification number of the slot machine 10, and the like, and then outputs the ticket as the ticket 175 with a barcode.

The card reader 172 reads out data from the smart card and transmits the data to the main CPU 71, or writes data into the smart card based on a control signal from the main CPU 71.

The key switch 173S is provided in the keypad 173, and outputs a predetermined input signal to the main CPU 71 when the keypad 173 has been operated by the player.

The data display 174 displays data read by the card reader 176 and data inputted by the player through the keypad 173, based on a control signal outputted from the main CPU 71.

(Graphic Board)

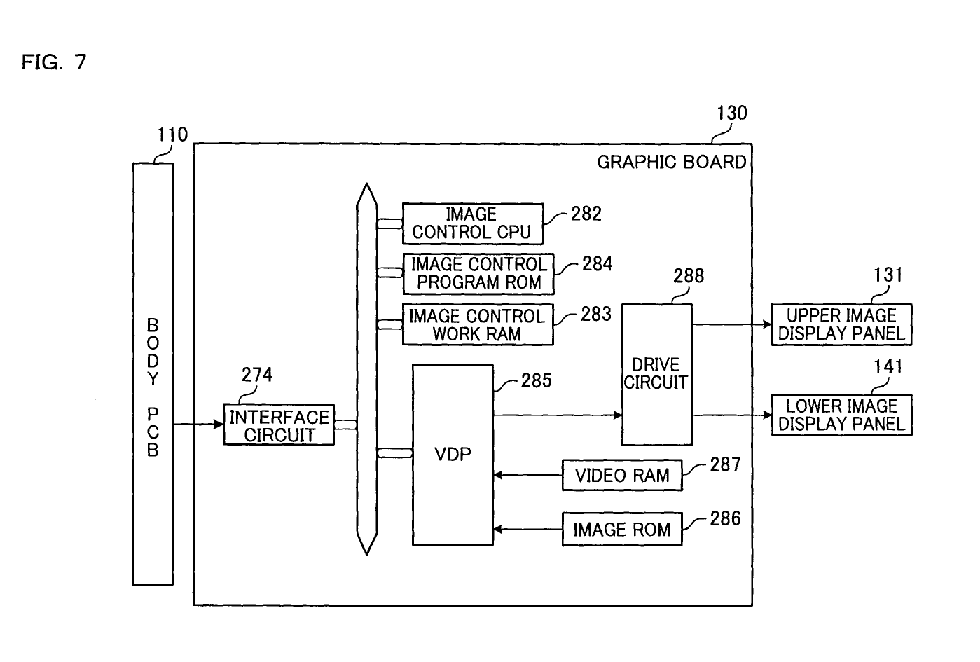

Further, as shown in FIG. 7, the body PCB 110 is connected to the graphic board 130 serving as a display control means for the upper image display panel 131 and the lower image display panel 141. The graphic board 130 is structured on a substrate separate from the substrate having the motherboard 70 and the body PCB 110, and performs display control of the upper image display panel 131 and the lower image display panel 141, based on video signals from the body PCB 110. Note the graphic board 130 may share the same power source used for powering the motherboard 70 and the body PCB 110. Alternatively, the graphic board 130 may be powered by a separate power sources. The graphic board 130 may be connected to the motherboard 70 to directly receive the video signal from the motherboard 70.

The graphic board 130 is structured by an interface circuit 274, an image control CPU 282, an image control program ROM 284, an image control work RAM 283, a VDP (Video Display Processor) 285, an image ROM 286, a video RAM 287, and a drive circuit 288.

The interface circuit 274 converts signals from the body PCB 110 to signals that can be processed by the image control CPU 282.

The image control CPU 282 performs controls according to control instructions received from the motherboard 70 and the body PCB 110. Further, the image control CPU 282 determines the contents to be displayed on the upper image display panel 131 and the lower image display panel 141 according to the image control program. Specifically, the image control CPU 282 runs an operation program stored in the image control program ROM 284, and reads out display control data for display control from the image control program ROM 284 while using the image control work RAM 283 as an work area. Then, based on the display control data having been read out and a display control command from the body PCB 110, the image control CPU 282 performs the display control process and transmits a draw command to VD 285.

The image control program ROM 284 stores a control program such as process routines executed by the image control CPU 282 and data tables.

The image control work RAM 283 is structured as means for temporarily storing the control program, when running the same by the image control CPU 282.

The VDP 285 has a display device control function and a high-speed drawing function, a function of performing processes of editing (enlarging/shrinking, trimming) or combining still and moving images according to draw commands from the image control CPU 282, and a function of clipping and outputting a part of an image expanded. Further, the VDP 285 is also capable of expanding compressed moving image data.

The image ROM 286 stores dot data for forming an image. The video RAM 287 is structured as a temporary storage for use when the VDP 285 forms an image.

The drive circuit 288 drives the upper image display panel 131 and the lower image display panel 141 to output an image, in response to signals from the VDP 285.

(Symbols, Combinations, or the like)

Symbols displayed on the video reels 151 to 155 of the slot machine 10 form symbol columns each including plural symbols 501. Each symbol 501 forming a symbol column is given any of the code numbers 0 to 19 or more, as shown in FIG. 8. Each symbol column has a combination of symbols 501 which are: “9”, “10”, “A”, “J”, “Q”, “SWORD”, “CLUB”, “REINDEER”, “RHINO”, “BUFFALO”, “FEATURE”, and “WILD”.

As shown in FIG. 5, any four consecutive symbols 501 of a symbol column are displayed (arranged) in the uppermost stage, upper stage, lower stage, and lowermost stage of the corresponding one of the video reels 151 to 155, respectively, thereby forming a symbol matrix of five columns and four rows on the display window 150. Symbols 501 forming a symbol matrix are scrolled when a game is started at least by pressing the spin button 31. The scrolling of the symbols 501 stops (symbols 501 are rearranged), when a predetermined period elapses after the start of scrolling.

Further, for symbols 501, various winning combinations are set beforehand. Each winning combination means a winning is achieved. A winning combination is a combination of symbols 501 stopped on the payline L, which is advantageous for a player. The wording “advantageous” means that: a predetermined number of coins according to the winning combination are paid out; the number of coins to be paid out is added to the credit; and a feature game is started; or the like.

In the present embodiment, a winning combination is a combination of symbols 501 which is rearranged on an activated payline L and includes a predetermined number of at least one of the following symbols 501: “9”, “10”, “A”, “J”, “Q”, “SWORD”, “CLUB”, “REINDEER”, “RHINO”, “BUFFALO”, “FEATURE”, and “WILD”. When a predetermined type of symbols 501 is set as a scatter symbol, a winning combination is regarded as to be formed if a predetermined number or more of scatter symbols are rearranged, irrespective of the activation/inactivation status of the paylines L.

Specifically, a winning combination with “FEATURE” (a feature symbol 503b) stopped on a payline L causes the feature IN and causes (i) transition of the gaming mode from the base game to the feature game and (ii) a payout according to the bet amount. Further, when the winning combination includes a symbol 501 “CLUB” stopped on the payline L during the base game, there is paid out an amount of coins (value) which is a product of a basic payout amount multiplied by the bet amount.

(Base Game symbol Table)

FIG. 8 shows a table used for determining symbols 501 to be rearranged during a base game. The base game symbol table indicates symbols 501 of each symbol column for the display blocks 28, code numbers. respectively associated with the symbols 501, and twenty number ranges respectively associated with the code numbers. The number ranges cover 0 to 65535.

Note that the above numbers may be equally divided into twenty ranges or unequally divided into twenty ranges.

The latter case enables adjustment of a winning possibility for each symbol 501 by adjusting the associated range of random numbers. Further, the range of random numbers associated with a bonus symbol 503, i.e. “FEATURE” serving as the feature symbol 503b or “WILD” serving as a wild symbol 503a, may be narrower than ranges of random numbers associated with other symbols 501. This allows easier adjustment of winning or losing, by adjusting the possibility of winning of a valuable symbol 501 according to the condition of the game.

For example, when a random number randomly selected for the first column is “10000”, the symbol “J” whose code No. “3” is associated with a range of random numbers including “10000” is selected as a symbol to be rearranged in the first video reel 151. Further, for example, when a random number randomly selected for the fourth column is “40000”, the symbol “FEATURE” whose code No. “12” is associated with a range of random numbers including “40000” is selected as a symbol to be rearranged in the fourth video reel 154.

(Payout Table)

FIG. 9 is a payout table for managing payout awarded based on the winning combination. This payout table is stored in the ROM 72 of the motherboard 70, and payout information (payout multiplying factor) is associated with each winning combination. For example, a payout multiplying factor corresponding to a winning combination including three “A” is “4”. Therefore, a payout calculated by multiplying a bet amount by 4 is awarded to a player in this case. A payout multiplying factor corresponding to a winning combination including five “BUFFALO” is “100”. Note that the payout multiplying factor for the base game is the same as that of the feature game; however, the present invention is not limited to this. That is, the setting of payout multiplying factor may be different between the base game and the feature game.

(Corresponding Bonus Symbol Table)

FIG. 10 shows the corresponding bonus symbol table indicating the odds for character equipment based on a character and stage combination and the corresponding amount of increase in the number of the bonus symbols 503. This corresponding bonus symbol table is stored in the ROM 72 of the motherboard 70. The table includes a combination of characters determined based on a selection by the player and stages randomly determined thereafter, and associated random determination odds for the character equipment. Further, the table also includes amounts of increase in the number of bonus symbols 503 in the feature game, which are associated with the character equipment. For example, when the player selects “wizard” as the character and “church” is determined as to be the stage thereafter, the random determination odds of the items to be equipped for the character are: 10% for “stick”, 20% for “cane”, 30% for “crystal”, and 40% for “cape”. Further, for example, when the “crystal” is determined as to be the item to be equipped as a result of random determination, the additional bonus symbols 503 include eight additional wild symbols 503a and two additional feature symbols 503b. The distribution of the random determination odds may be suitably set.

As is understood from this, the random determination odds for determining the advantageous condition of the feature game are varied, based on a combination of the character setting selected by the player and the stage setting which is randomly determined. This structure allows wider variation of the advantageous conditions to be determined, than a structure that determines the advantageous condition when the player selects the character setting. Thus, there is provided a slot machine 10 having an improved entertainment characteristic.

(Corresponding Random Number Table)

FIG. 11 shows the corresponding random number table indicating the random determination odds of the character equipment and the corresponding random numbers. The corresponding random number table indicates the random determination odds of the character equipment and the corresponding random numbers. As sown in FIG. 10, the random determination odds of the character equipment are: 10%, 20%, 30%, and 40% based on the combination of the character setting and the stage setting. This random determination odds are associated with ranges of random numbers, respectively, as shown in FIG. 11. For example, a range of random numbers 0 to 6554 is associated with the random determination odds of “10%”.

(Symbol Column Determination Table)

FIG. 12 shows a symbol column determination table used at the time of determining a symbol column in which addition of or replacement with the bonus symbols 503 takes place. The symbol column determination table indicates symbol column numbers and random number ranges respectively associated with the symbol column numbers. The symbol column No. 1 corresponds to the first column of the display blocks 28; the symbol column No. 2 to the second column of the display blocks 28; the symbol column No. 3 to the third column of the display blocks 28; the symbol column No. 4 to the fourth column of the display blocks 28; and the symbol column No. 5 to the fifth column of the display blocks 28.

The present embodiment deals with a case where an increase in the number of bonus symbols 503 or the number of bonus symbols 503 to replace the other symbols is determined for each symbol column based on the random number sampled and the symbol column determination table. The present invention however is not limited to this. For example, the number of bonus symbols 503 to be increased or to replace the other symbols may be determined in advance for each symbol column. Further, an increase in the number of bonus symbols 503 or the number of bonus symbols 503 to replace the other symbols may be determined for each type of the bonus symbols 503.

(Code Number Determination Table)

FIG. 13 shows a code number determination table. The code number determination table indicates code numbers and random number ranges respectively associated with the code numbers. For example, when the random numbers for the first symbol column No. (the first column) are 40567, 63535, 65323, then “13”, “end”, and “end” are selected as the code numbers, respectively.

The present embodiment deals with a case where the code numbers of bonus symbols to be increased is determined for each of the symbol columns based on the random numbers obtained and the code number determination table. The present invention however is not limited to this. For example, the code number of a bonus symbol 503 to be increased may be set in advance for each symbol column.

(Feature Game symbol Table)

FIGS. 14A to 14B show a table for use at the time of determining symbols 501 to be rearranged during a feature game. As is the base game symbol table, the feature game symbol table contains symbols 501 of each symbol column for the display blocks 28, code numbers respectively associated with the symbols 501, and number ranges respectively associated with the code numbers The number ranges cover the numbers of 0 to 65535. These numbers 0 to 65535 are divided into the ranges as is the case of the base game symbol table.

In the feature game symbol table, the bonus symbol 503 is added or replaces another symbol. The wording “replacing” means that new symbol data is written over already existing symbol data. The number of additional symbols or the number of symbols replacing the other symbols, or the symbol column in which the addition or replacement takes place may be randomly determined or determined beforehand. The present embodiment deals with a case where the a predetermined number of bonus symbols 503 are added as a result of random determination, as is understood from FIG. 10. When symbol data is replaced with another set of symbol data, an image based on the overwritten data (replacement data) may be displayed, in place of a symbol 501 having been stopped and displayed.

For example, in the feature game symbol table of FIG. 14A, there are additional wild symbols 503a and feature symbols 503b in the symbol columns. For example, the third column includes additional wild symbol 503a assigned to code No.6, and an additional feature symbol 503b to code No.13. Further, another wild symbol 503a replaces symbol “J” assigned to code No.9. The feature game symbol table of FIG. 14A and FIG. 14B deals with a case where the character is equipped with a long spear. Therefore, there are twelve additional wild symbols 503a and three additional feature symbols 503b.

The data of each of the above described tables is stored in the ROM 72, the RAM 73 in the motherboard 70 (game controller 100) of the slot machine 10. This allows the slot machine 10 to run the base game and the feature game independently when it is separated from the external controller 200.

(Display Status)

The following describes an exemplary display status of the symbol display device 16 in the operation of the slot machine 10.

(Slot Game: Base Game Screen)

FIG. 15 shows an exemplary base game screen which is a screen displayed on the symbol display device 16, during the base game.

More specifically, the base game screen is arranged in a center portion, and includes: the display window 150 having the five video reels 151 to 155, and the payline occurrence parts 65L and 65R which are arranged on both sides of the display window 150 and symmetrical with respect to the display window 150. Note that FIG. 15 shows a base game screen in which the first to third video reels 151, 152, and 153 are stopped, while the fourth and fifth video reels 154 and 155 are rotating.

Above the display window 150 are: the credit amount display unit 400, the bet amount display unit 401, a wild symbol count display unit 415, a trigger symbol count display unit 416, and the payout display unit 402. These units 400, 401, 415, 416, and 402 are sequentially arranged in this order from the left side to the right side when viewed from a player.

The credit amount display unit 400 displays a credit amount. The bet amount display unit 401 displays a bet amount in a unit game in progress. The wild symbol count display unit 415 displays the number of wild symbols 503a in a unit game in progress. With this, it is possible to notify the player in advance that there are five wild symbols 503a in the base game. The trigger symbol count display unit 416 displays the number of feature symbols 503b in a unit feature game in progress. With this, it is possible to notify the player that there are five feature symbols 503b in the base game. The payout display unit 402 displays the number of coins to be paid out when a winning combination is achieved.

Below the display window 150 are: a help button 410; a pay-table button 411; a bet unit display unit 412; a stock display unit 413; and a feature game count display unit 414. These units 410, 411, 412, 413, and 414 are sequentially arranged in this order from the left side to the right side when viewed from the player.

The help button 410, when pressed by a player, activates a help mode. The help mode provides a player with information to solve his/her problem regarding the game. The pay-table button 411, when pressed by a player, activates a payout display mode in which an amount of payout is displayed. The payout display mode displays for the player an explanatory screen indicating relation of a winning combination to the payout multiplying factor.

The bet unit display unit 412 displays a bet unit (payout unit) at the current point. With the bet unit display unit 412, the player is able to know that, for example, the minimum game value required to participate in a unit game is one cent, and that he/she is able to raise his/her bet in increments of one cent.

The stock display unit 413 displays a feature game carry-over number. Here, the “number of feature games carried over” means the remaining number of feature games runnable subsequently to an end of the currently-run feature game. That is, when the stock display unit 413 displays “3”, three more feature games are runnable after the currently-run feature game. Note that “0” is displayed during the base game.

A feature game count display unit 414 displays the total number of times the feature game is to be repeated, and how many times the feature game has been repeated. That is, when the feature game count display unit 414 displays “0 OF 0”, the total number of times a feature game is to be repeated (“feature game total number”) is 0; that is, the game in progress is not a feature game. Further, when the feature game count display unit 414 displays “5 OF 8”, during the feature game, the feature game total number is eight, and the current game in progress is the fifth feature game.

(Feature IN screen in Base Game)

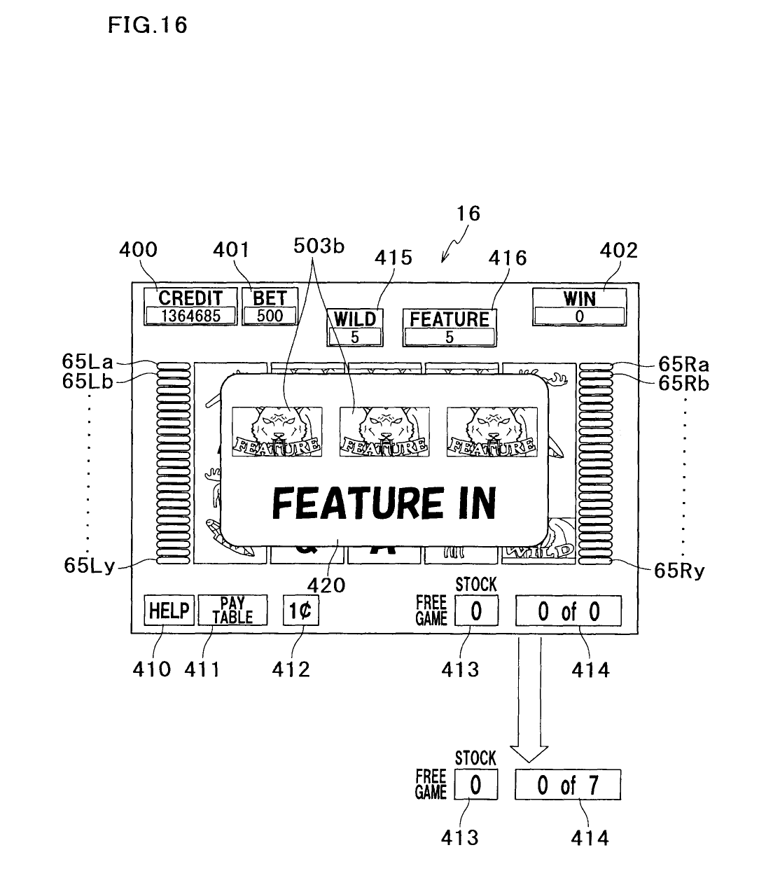

FIG. 16 shows a screen displayed for a predetermined period after the feature IN. More specifically, the figure shows the screen after the feature IN caused by rearrangement of three feature symbols 503b. The feature symbol 503b preferably has a readable text such as “FEATURE”, so as to have a player clearly understand the symbol 501 relates to the feature IN.

On this screen, a bonus-win screen 420 is pop-up displayed which notifies the player of the feature IN using a symbol image and an image of text of “FEATURE IN”. Then, at the same time or immediately after displaying the bonus-win screen 420, the free game total number “0” of the feature game count display unit 414 is switched to “7”. Thus, the player is able to know that s/he won a bonus, and that the game will transit to a feature game in which the feature game is repeated seven times.

(Slot game: Feature Game Screen)

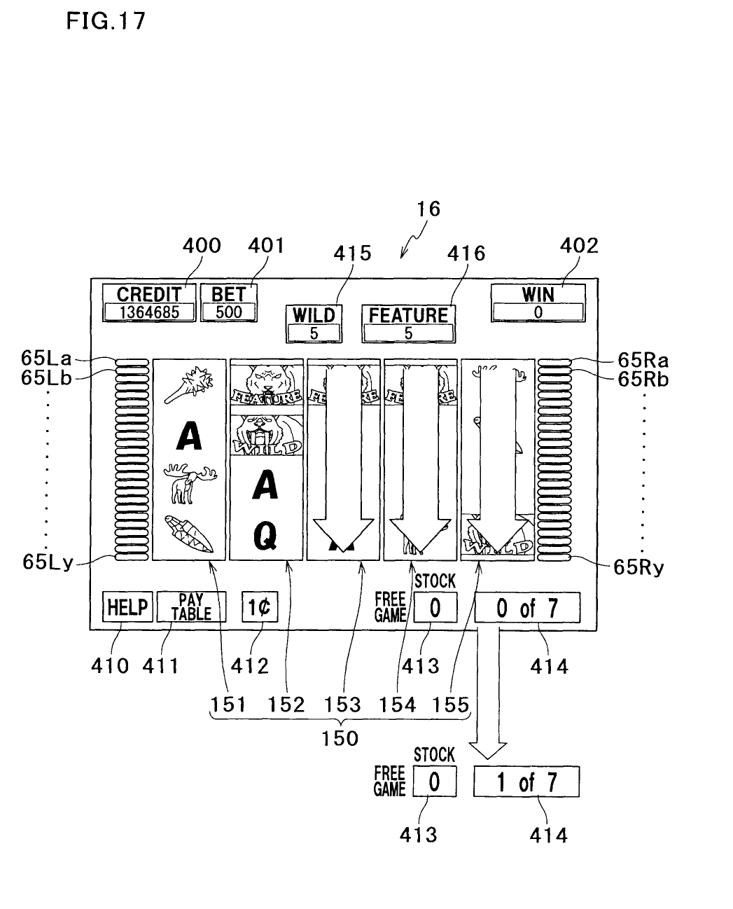

FIG. 17 shows an exemplary feature game screen which is a screen displayed on the symbol display device 16, during the feature game.

Specifically, the feature game count display unit 414 displays the feature game total number and the what number game the current game is. For example, the feature game count display unit 414 indicates that the first feature game out of seven feature games is running. Other operations are the same as the base game.

<Main Control Process>

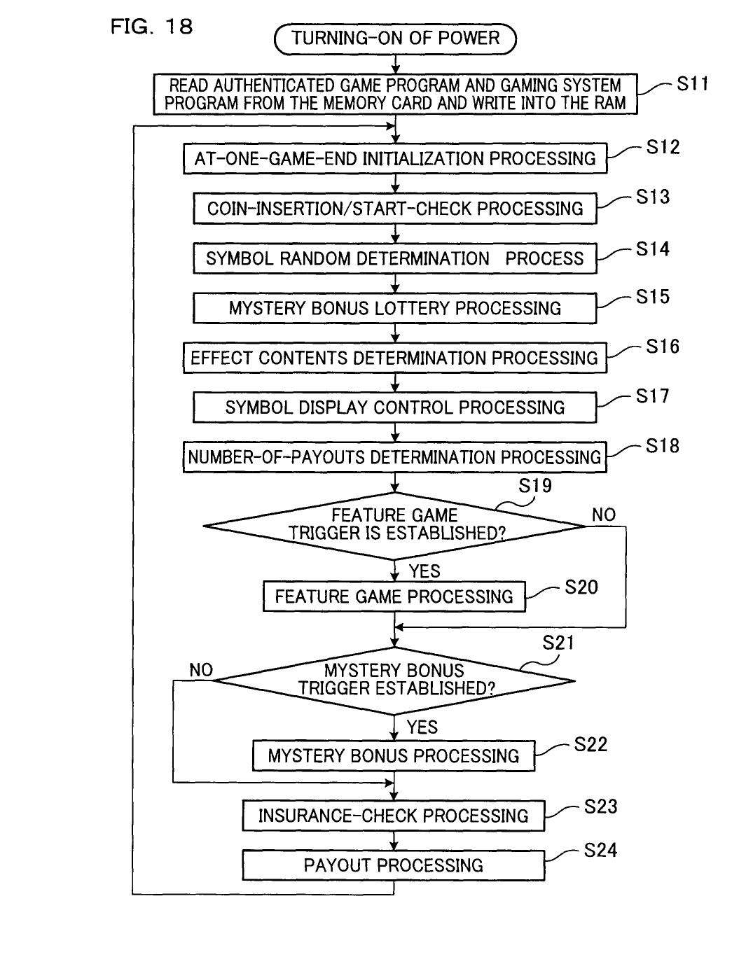

Next, with reference to FIGS. 18 to 24, the program to be executed by the slot machine 10 is described.

First, with reference to FIG. 18, a main control process is described.

First, when the power is supplied to the slot machine 10, the main CPU 71 reads the authenticated game program and gaming system program from the memory card 54 through the gaming board 50, and writes the programs into the RAM 73 (S11).

Next, the main CPU 71 conducts at-one-game-end initialization process (step S12). For example, data that becomes unnecessary after each game in the working areas of the RAM 73, such as the number of bets and the randomly determined symbols 501 is cleared.

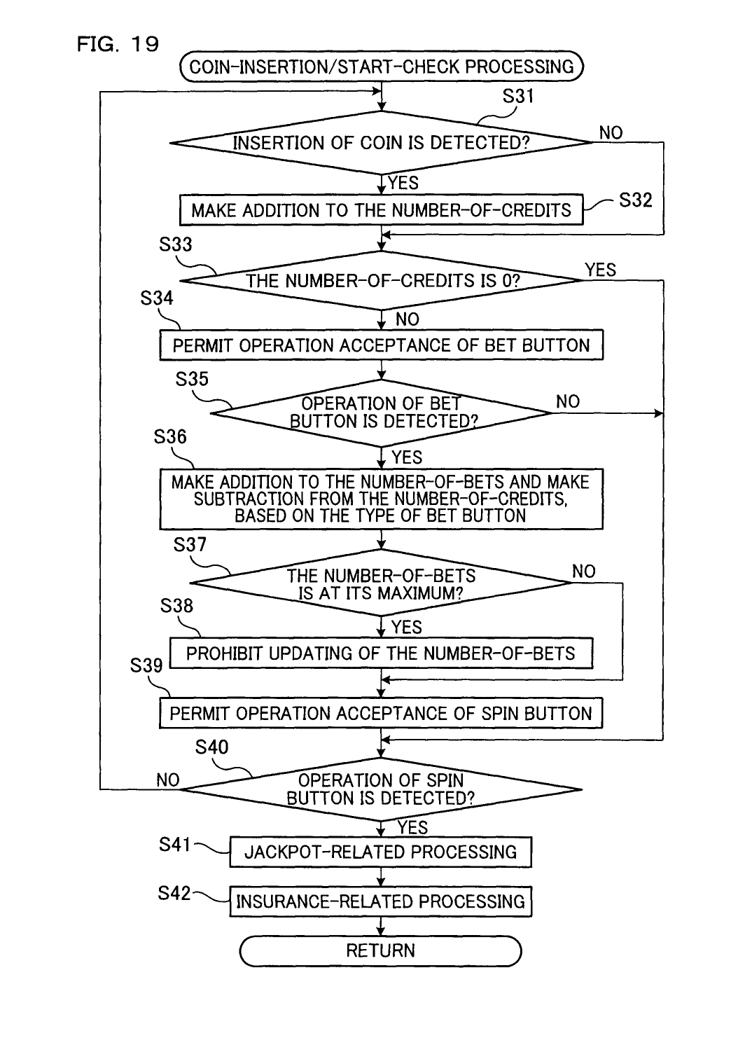

Next, the main CPU 71 conducts coin-insertion/start-check process which is described later with reference to FIG. 19 (step S13). This process performs input checking in relation to the 1-bet switch 34S, the maximum bet switch 35S, and the spin switch 31S.

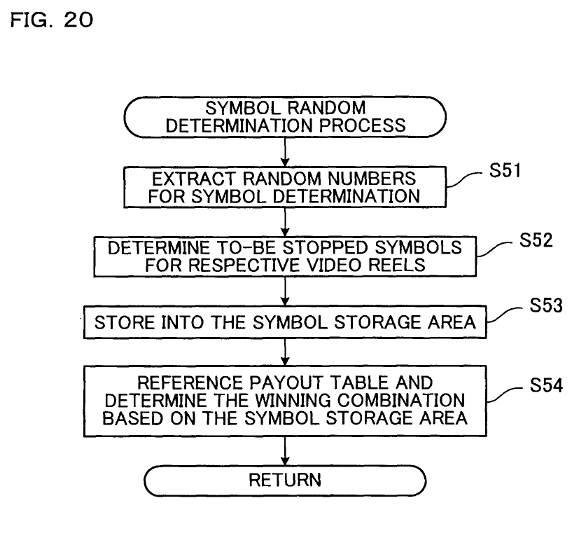

Next, the main CPU 71 performs a symbol random-determination process which is described later with reference to FIG. 20 (step S14). In the process, to-be-stopped symbols 501 are determined based on the random numbers for symbol determination.

Next, the main CPU 71 conducts mystery bonus process (step S15). In the process, a process of randomly determining whether or not to establish a mystery bonus trigger is held. For example, the main CPU 71 extracts a random number for mystery bonus from the numbers in a range of “0 to 99”, and establishes the mystery bonus trigger when the extracted random number is “0”.

The main CPU 71 conducts effect contents determination process (step S16). The main CPU 71 extracts a random number for effect, and randomly determines any of the effect contents from the preset plurality of effect contents.

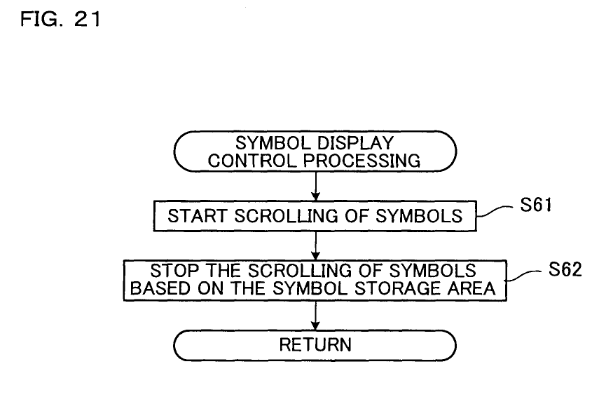

The main CPU 71 then performs a symbol display control process which is described later with reference to FIG. 21 (step S17). In the process, scrolling of the symbol column of each video reel (151 to 155) is started, and the to-be-stopped symbol 501 determined in the symbol random-determination process of step S14 is stopped at a predetermined position. For example, when the to-be-stopped symbol 501 is the symbol associated with the code number of “10” shown in FIG. 8 and it is to be displayed to the upper region, the symbols associated with the respective code numbers of “11”, “12” and “13” are to be displayed to the respective upper central region, lower central region and lower region of the lower image display panel 141.

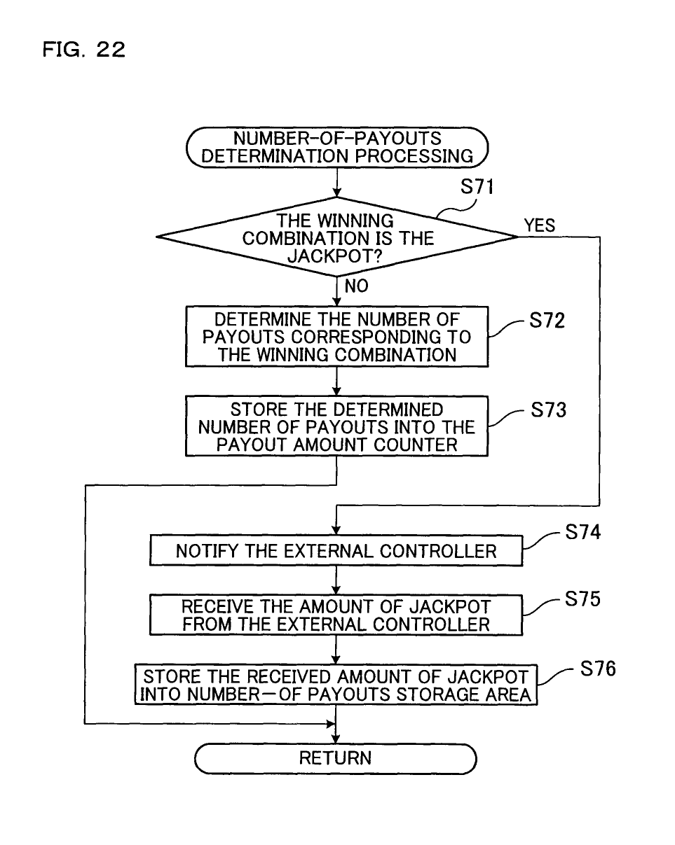

Next, the main CPU 71 performs a number-of-payouts determination process which is described later with reference to FIG. 22 (step S18). In the process, the number of payouts is determined based on the combination of symbols 501 displayed along the payline L, and is stored into a payout amount counter provided in the RAM 73.

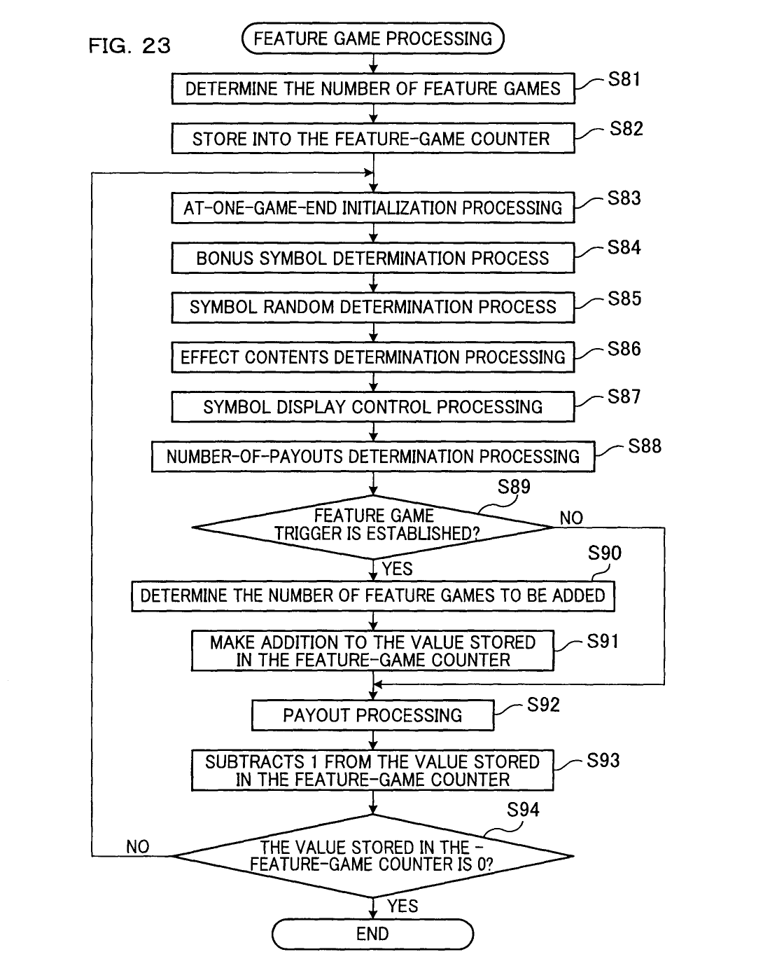

The main CPU 71 then determines whether or not the feature game trigger has been established (step S19). That is, the main CPU 71 determines whether three or more feature symbols 503b are arranged in the video reels 151 to 155 displayed on the lower image display panel 141. When the main CPU 71 determines that the feature game trigger has been established, the main CPU 71 conducts feature game process which is described later with reference to FIG. 23 (step S20).

After the process of step S20 or when determining in step S19 that the feature game trigger has not been established, the main CPU 71 determines whether or not the mystery bonus trigger is established (step S21). When determining that the mystery bonus trigger has been established, the main CPU 71 conducts the mystery bonus process (step S22). In the process, the number of payouts (e.g. 300) being set for the mystery bonus is stored into the payout amount counter provided in the RAM 73.

After the process of step S22 or when determining in step S21 that the mystery bonus trigger has not been established, the main CPU 71 conducts insurance-check process (step S23). In the process, whether or not to conduct payout by the insurance is checked.

The main CPU 71 conducts a payout process (step S24). The main CPU 71 adds the value stored in the payout amount counter to the credit amount counter provided in the RAM 73. It is to be noted that operations of the hopper 113 may be controlled based on input from the cashout switch 33S, and coins of the number corresponding to the value stored in the payout amount counter may be discharged from the coin outlet port 15. Further, operations of the ticket printer 171 may be controlled and a ticket 175 with a barcode may be issued on which a value stored in the payout amount counter is recorded. After the process has been conducted, the process is shifted to step S12.

<Coin-Insertion/Start-Check Process>

Next, with reference to FIG. 19, a coin-insertion/start-check process is described.

First, the main CPU 71 determines whether or not insertion of a coin has been detected by the coin counter 36C (step S31). When determining that the insertion of a coin has been detected, the main CPU 71 makes an addition to the credit amount counter (S32). It is to be noted that, in addition to the insertion of a coin, the main CPU 71 may determine whether or not insertion of a bill has been detected by the bill validator 22, and when determining that the insertion of a bill has been detected, the main CPU 71 may add a value according to the bill to the credit amount counter.

After S32 or when determining in S31 that the insertion of a coin has not been detected, the main CPU 71 determines whether or not the credit amount counter indicates zero (S33). On the other hand, when the main CPU 71 determines that the value of the credit amount counter is not zero, the main CPU 71 permits operation acceptance of the 1-bet button 34 and the maximum bet button 35 (S34).

Next, the main CPU 71 determines whether or not an operation of the 1-bet button 34 or the maximum bet button has been detected (S35). When the main CPU 71 determines that an operation of the 1-bet button 34 or the maximum bet button 35 by the player has been detected via the 1-bet switch 34S or the maximum bet switch 35S, the main CPU 71 makes an addition to the bet amount counter provided in the RAM 73 and makes a subtraction from the credit amount counter, based on the type of the bet buttons (S36).

The main CPU 71 then determines whether or not the value of the bet amount counter is at its maximum (S37). When the main CPU 71 determines that the value of the bet amount counter is at its maximum, the main CPU 71 prohibits updating of the bet amount counter (S38). After S38 or when determining in S37 that the bet amount counter is not at its maximum, the main CPU 71 permits operation acceptance of the spin button 31(S39).

When it is determined in S35 after S39 that an operation of the 1-bet button 34 or an operation of the maximum bet button 35 is not detected, or when determining in S33 that the credit amount counter indicates zero, the main CPU 71 determines whether or not an operation of the spin button 31 is detected (S40). When the main CPU 71 determines that the operation of the spin button 31 has not been detected, the process is shifted to step S31.

When the main CPU 71 determines that the operation of the spin button 31 has been detected, the main CPU 71 conducts a jackpot-related process (step S41). In the process, the amount to be accumulated to the amount of jackpot is calculated, and the amount is transmitted to the external controller 200.

Next, the main CPU 71 conducts an insurance-related process (S42). In the process, counting of the number of games is conducted which triggers a payout by the insurance. After the process has been conducted, the coin-insertion/start-check process is completed.

<Symbol Random-Determination Process>

Next, with reference to FIG. 20, the symbol random-determination process is described.

First, the main CPU 71 extracts random numbers for symbol determination (step S51). The main CPU 71 then randomly determines to-be-stopped symbols 501 for the respective video reels 151 to 155 (step S112). The main CPU 71 randomly determines any one of the 20 symbols (code numbers from “00” to “19”) as a to-be-stopped symbol 501, for each video reel 151 to 155. At this time, each of the symbols 501 (code numbers from “00” to “19”) is determined at an equal probability (i.e. 1/20).

The main CPU 71 then stores the determined to-be-stopped symbols 501 for the respective video reels 151 to 155 into a symbol storage area provided in the RAM 73 (step S53). Next, the main CPU 71 references the payout table (FIG. 9) and determines a winning combination based on the symbol storage area (step S54). The main CPU 71 determines whether or not the combination of symbols 501 to be displayed along the payline L by the respective video reels 151 to 155 matches any of the combinations of symbols 501 specified by the payout table, and determines the winning combination. After the process has been conducted, the symbol random-determination process is completed.

<Symbol Display Control Process>

Next, with reference to FIG. 21, the symbol display control process is described.

First, the main CPU 71 starts scrolling of the symbol columns of the respective video reels 151 to 155 that are displayed on the lower image display panel 141 (step S61). The main CPU 71 then stops the scrolling of the symbol columns of the respective video reels 151 to 155, based on the aforementioned symbol storage area (S62). After the process has been conducted, the symbol display control process is completed.

<Number-of-Payouts Determination Process>

Next, with reference to FIG. 22, the number-of-payouts determination process is described.

The main CPU 71 first determines whether or not the winning combination is the jackpot (step S71). When the main CPU 71 determines that the winning combination is not the jackpot, the main CPU 71 determines the number of payouts corresponding to the winning combination (step S72). For example, where the winning combination is three “A” symbols, the number of payouts is “4” (see FIG. 9). It is to be noted that the main CPU 71 determines “0” as the number of payouts in the case where the game is lost. Next, the main CPU 71 stores the determined number of payouts into the payout amount counter (step S73). After the process has been conducted, the number-of-payouts determination process is completed.

When the main CPU 71 determines that the winning combination is the jackpot, the main CPU 71 notifies the external controller 200 of the winning of the jackpot (step S74). It is to be noted that, upon reception of the notification, the external controller 200 transmits to the slot machine 10 the amount of jackpot having updated up to that time. At this time, a part (e.g. 80%) of the amount of jackpot may be the payout subject and the rest (e.g. 20%) may be carried over for the upcoming establishment of the jackpot trigger.

Next, the main CPU 71 receives the amount of jackpot from the external controller 200 (step S75). The main CPU then stores the received amount of jackpot into the payout amount counter (step S76). After the process has been conducted, the number-of-payouts determination process is completed.

(Feature Game Process)

Next, with reference to FIG. 23, the feature game process is described.

First, the main CPU 71 determines the number of feature games (S81). The main CPU 71 extracts a random number for number-of-feature-game determination, and randomly determines any one of the various feature games such as “50”, “70” and “100”.

Next, the main CPU 71 stores the number of feature games thus determined in the feature game counter provided in the RAM 73 (S82).

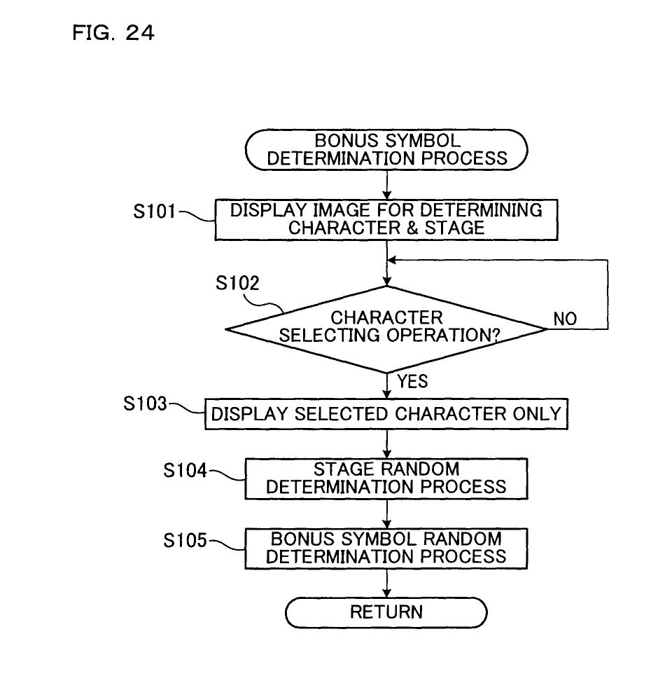

The main CPU 71 then conducts at-one-game-end initialization process in the same way as the process of step S12 described with reference to FIG. 18 (step S83). Next, the main CPU 71 performs a bonus symbol determination process which is described later with reference to FIG. 24 (step S84).

The main CPU 71 then performs the symbol random-determination process described with reference to FIG. 20 (step S85). Then, the main CPU 71 conducts the effect contents determination process in the same way as the process of step S16 described with reference to FIG. 18 (step S86). Next, the main CPU 71 performs the symbol display control process described with reference to FIG. 21 (step S87). The main CPU 71 then performs the number-of-payouts determination process described with reference to FIG. 22 (step S88).

The main CPU 71 then determines whether or not the feature game trigger has been established (step S89). That is, the main CPU 71 determines whether or not three or more feature symbols 503b are arranged on the video reels 151 to 155 displayed on the lower image display panel 141. When the main CPU 71 determines that the feature game trigger has been established, the main CPU 71 determines the number of feature games to be added (step S90). Next, the main CPU 71 adds up the number of feature games determined to the value of the feature game counter (S91).

After S91 or when determined in S89 that the feature game trigger is not met, the main CPU 71 performs a payout process (S92). In this payout process, the main CPU 71 adds up, to the value of the bonus payout amount counter, the value of the payout amount counter stored in the number-of-payouts determination process in S88. The bonus payout amount counter is for managing the total of the pay out numbers determined in the feature games.

When the feature game process has been completed, the main CPU 71 adds the value stored in the bonus payout amount counter to the value stored in the credit amount counter provided in the RAM 73, in the payout process of step S24 described with reference to FIG. 18. That is, the total of the numbers of payouts determined during the feature games is collectively paid out. Here, it is to be noted that coins may be discharged from the coin outlet port 15, or a ticket 175 with a barcode may be issued.

Next, the main CPU 71 reduces the value of feature game counter by 1 (S93). Next, the main CPU 71 determines whether or not the value of feature game counter is 0 (S94). If the main CPU 71 determines that the value of the feature game counter is not 0, the process goes to S83. On the other hand when the main CPU 71 determines that the value of the feature game counter is 0, the feature game process is completed. When the feature game process has been completed, the process goes to the process of step S21 described with reference to FIG. 18.

(Bonus Symbol Determination Process)

Next, with reference to FIG. 24, the bonus symbol determination process is described.

First, the main CPU 71 displays the character setting image and the stage setting image (S101). That is, the main CPU 71 displays the character setting image on the lower image display panel 141 and the stage setting image on the upper image display panel 131, as shown in FIG. 1.

Next, the main CPU 71 determines whether or not the player selected the character (S102). That is, the main CPU 71 determines whether or not the player has pressed the selection button 500 to select a desirable one of the four characters displayed. When the main CPU 71 determines that the player has not yet selected the character, the main CPU 71 waits for selection to be mad.

On the other hand, when the main CPU 71 determines that the player has pressed the selection button 500 to select the character, the main CPU 71 erases images of all the characters except for the selected character, and displays only the image of the selected character on the lower image display panel 141 (S103).

Next, the main CPU 71 randomly determines one of the four stages displayed on the upper image display panel 131 (S104).

Next, the main CPU 71 executes the bonus symbol random-determination process (S105). In this process, the main CPU 71 determines the random determination odds based on the combination of the character selected by the player in S102 and the stage randomly determined in S104. Based on the random determination odds, the bonus symbols 503 in the feature game are randomly determined. That is, as shown in FIG. 10, the random determination odds for the items to be equipped by the character are determined based on the combination of the character selected by the player and the stage randomly determined by the main CPU 71. Based on the random determination odds, the item to be equipped by the character in the feature game is determined. The items to be equipped are associated with amounts of increase in the number of the bonus symbols 503 in the feature game. Therefore, the bonus symbols 503 in the feature game are determined in the process of S105. After this process, the bonus symbol determination process is completed.

According to the structure and operation of the slot machine 10 thus described, the slot machine 10 of the present embodiment includes:

a RAM 73 for storing a plurality of advantageous conditions (an amount of increase in the number of bonus symbols 503, or the like) each related to an advantage level of a player in a feature game, and for storing a plurality of character settings and a plurality of stage settings each related to an effect of the game;

a selection button 500 to be operated by the player for selecting one of the plurality of character settings stored in the RAM 73; and

a game controller 100,

wherein the game controller 100 is programmed to perform the processes of:

(a1) running a base game configured to award a payout according to a predetermined combination;

(a2) when the predetermined condition is met in the base game (e.g. three feature symbols 503b are arranged), shifting a gaming mode to a feature game which is more advantageous for the player than the base game;

(a3) receiving an operation of the selection button 500 by the player;

(a4) determining a character setting based on the operation by the player;

(a5) randomly determining a stage setting out of the plurality of stage settings stored in the RAM 73;

(a6) determining the random determination odds based on the combination of the character setting and the stage setting determined;

(a7) based on the random determination odds, randomly determining an advantageous condition out of the plurality of advantageous conditions stored in the RAM 73; and

(a8) running the feature game based on the advantageous condition determined.

As described, when a predetermined condition is met in the base game, the character setting is determined based on an operation of the selection button 500 by the player, and the stage setting is randomly determined. Based on a combination of the character setting and the stage setting, the random determination odds are determined, and the advantageous condition in the feature game is determined based on the random determination odds. Based on the advantageous condition thus determined, the feature game is run. As is understood from this, the random determination odds for determining the advantageous condition of the feature game are varied, based on a combination of the character setting selected by the player and the stage setting which is randomly determined. This structure allows wider variation of the advantageous conditions to be determined, than a structure that determines the advantageous condition when the player selects the character setting. Thus, there is provided a slot machine 10 having an improved entertainment characteristic.

Further, the slot machine 10 of the present embodiment may further include a notification device (upper image display panel 131, lower image display panel 141, lamp 111, speaker 112, or the like) for notifying the player of the advantageous condition, wherein the game controller 100 notifies the player of the advantageous condition determined via the notification device.

With the structure, the advantageous condition determined is notified to the player via the notification device. This may enable the player to grasp the level of the advantageous condition by effects such as displaying an image of a character with a stronger item or outputting a larger sound for a better advantageous condition. Thus, there is provided a slot machine 10 having an improved entertainment characteristic.

Further, the slot machine 10 of the present embodiment may further include a display device (upper image display panel 131, lower image display panel 141, or the like) for displaying an image, wherein the game controller 100 may display on the display device the character according to the character setting determined, and the item of the character according to the advantageous condition.

With this, the display device displays the character according to the character setting determined. Further, an item of the character is displayed on the display device according to the advantageous condition determined. This may enable the player to grasp the level of the advantageous condition by effects such as displaying an image of a character with a stronger item for a better advantageous condition. Thus, there is provided a slot machine 10 having an improved entertainment characteristic.

Thus, the present embodiment is described hereinabove. The present invention however may be as described in another embodiment described below. In the following description about a slot machine 10 of the other embodiment, no further description is provided for the parts and members that are identical to the foregoing embodiment, and only those that are different from the foregoing embodiment are described.

### Another Embodiment

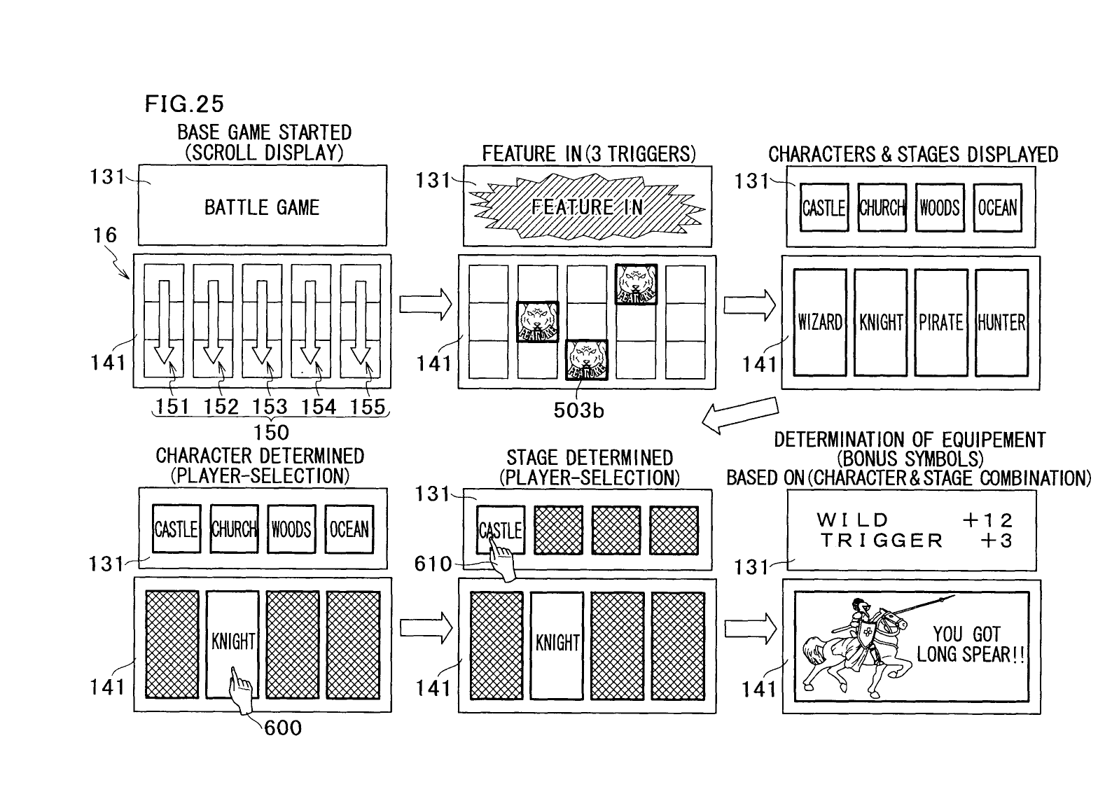

For example, as shown in FIG. 25, a slot machine 10 of the other embodiment of the present invention a playing method including the steps of:

running a base game capable of awarding a payout according to a predetermined combination;

when three feature symbols 503b are rearranged in the base game, shifting the gaming mode to a feature game which is more advantageous for a player than the base game;

receiving an operation of by the player;

determining one of a plurality of character settings for effects of the game, based on the operation by the player;

determining one of a plurality of stage settings for effects of the game, based on the operation by the player; determining random determination odds based on a combination of the character setting determined and the stage setting determined;

based on the random determination odds, randomly determining one of a plurality of advantageous conditions relative to an advantage level of the player in the feature game; and

running a feature game based on the advantageous condition thus determined.

For example, as shown in FIG. 25, when the base game starts, the video reels 151 to 155 on the lower image display panel 141 of the symbol display device 16 rotate to rearrange the symbols 501. At this time, if three or more feature symbols 503b are arranged, the feature IN occurs, and the occurrence of the same is displayed on the upper image display panel 131.

When the feature IN occurs, a character setting image is displayed on the upper image display panel 131. Further, at the same time, a stage setting image is displayed on the lower image display panel 141. Thus, the player is able to visually grasp the character and the stage of the feature game.

When the character setting image and the stage setting image are displayed, the character selection cursor 600 is displayed on the lower image display panel 141. The player is able to move this character selection cursor 600 horizontally by pressing the selection button 500. Doing so enables the player to select a desirable character out of the plurality of characters.

When a character is selected by the player, a stage selection cursor 610 is displayed on the upper image display panel 131. The player is able to move this stage selection cursor 610 horizontally by pressing the selection button 500. Doing so enables the player to select a desirable stage out of the plurality of stages.

When the character setting and the stage setting are determined, the random determination odds are determined based on the combination of the character setting and the stage setting. Based on the random determination odds determined, there is determined the bonus symbols 503 in the feature game, which correspond to the equipment of the character determined. For example in FIG. 25, the player has selected “knight” as the character setting, and “castle” as the stage setting. Based on this combination of the “knight” and “castle” thus determined, the random determination odds are determined, and the long spear is determined as the equipment through a random determination based on the random determination odds. At this time, the lower image display panel 141 displays an image of a knight equipped with a long spear. Further, the upper image display panel 131 displaying an image indicating the additional bonus symbols 503 (twelve additional wild symbols 503a and three additional feature symbols 503b) with which the long spear as the equipment is associated. Then, the feature game is run with an increased number of bonus symbols 503.

### Bonus Symbol Determination Process of the Other Embodiment

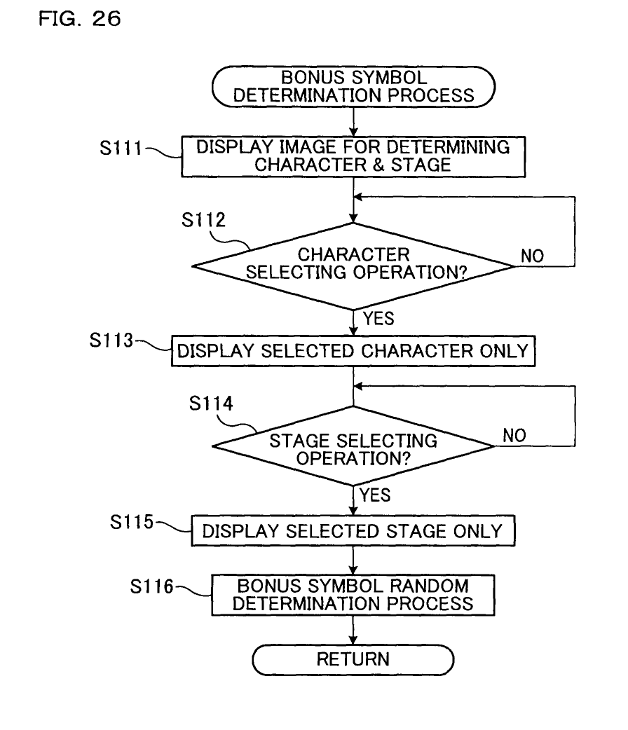

The following describes a bonus symbol determination process of the other embodiment, with reference to FIG. 26.

First, the main CPU 71 displays the character setting image and the stage setting image (S111). That is, the main CPU 71 displays the character setting image on the lower image display panel 141 and the stage setting image on the upper image display panel 131, as shown in FIG. 25.

Next, the main CPU 71 determines whether or not the player selected the character (S112). That is, the main CPU 71 determines whether or not the player has pressed the selection button 500 to select a desirable one of the four characters displayed. When the main CPU 71 determines that the player has not yet selected the character, the main CPU 71 waits for selection to be mad.

On the other hand, when the main CPU 71 determines that the player has pressed the selection button 500 to select the character, the main CPU 71 erases images of all the characters except for the selected character, and displays only the image of the selected character on the lower image display panel 141 (S113).

Next, the main CPU 71 determines whether or not the player selected the stage (S114). That is, the main CPU 71 determines whether or not the player has pressed the selection button 500 to select a desirable one of the four stages displayed. When the main CPU 71 determines that the player has not yet selected the stage, the main CPU 71 waits for selection to be made.

On the other hand, when the main CPU 71 determines that the player has pressed the selection button 500 to select the stage, the main CPU 71 erases images of all the stages except for the selected stage, and displays only the image of the selected stage on the lower image display panel 141 (S115).

Next, the main CPU 71 executes the bonus symbol random-determination process (S116). In this process, the main CPU 71 determines the random determination odds based on the combination of the character and the stage selected by the player in S112 in 5114, respectively. Based on the random determination odds, the bonus symbols 503 in the feature game are randomly determined. That is, as shown in FIG. 10, the random determination odds for the items to be equipped by the character are determined based on the combination of the character and the stage selected by the player. Based on the random determination odds, the item to be equipped by the character in the feature game is determined. The items are associated with amounts of increase in the number of the bonus symbols 503 in the feature game. Therefore, the bonus symbols 503 in the feature game are determined in the process of S116. After this process, the bonus symbol determination process is completed. In the present embodiment, the player presses a single button (selection button 500) to select the characters and stage. However, it is possible to use separate buttons for selecting the character and stage, respectively.

According to the structure and operation of the slot machine 10 thus described, the slot machine 10 of the present embodiment includes:

a RAM 73 for storing a plurality of advantageous conditions (an amount of increase in the number of bonus symbols 503, or the like) each related to an advantage level of a player in a feature game, and for storing a plurality of character settings and a plurality of stage settings each related to an effect of the game;

a selection button 500 to be operated by the player for selecting one of the plurality of character settings stored in the RAM 73, the selection button 500 being used also for selecting one of the plurality of stage settings stored in the RAM 73; and

a game controller 100,

wherein the game controller 100 is programmed to perform the processes of:

(b1) running a base game configured to award a payout according to a predetermined combination;

(b2) when the predetermined condition is met in the base game (e.g. three feature symbols 503b are arranged), shifting a gaming mode to a feature game which is more advantageous for the player than the base game;

(b3) receiving an operation of the selection button 500 by the player;

(b4) determining the character setting and the stage setting based on the operation by the player;

(b5) determining the random determination odds based on the combination of the character setting and the stage setting determined;

(b6) based on the random determination odds, randomly determining an advantageous condition out of the plurality of advantageous conditions stored in the RAM 73; and

(b7) running the feature game based on the advantageous condition determined.

As described, when a predetermined condition is met in the base game, the character setting is determined based on an operation of the selection button 500 by the player, and the stage setting is further determined based on an operation of the selection button 500 by the player. Based on a combination of the character setting and the stage setting, the random determination odds are determined, and the advantageous condition in the feature game is determined based on the random determination odds. Based on the advantageous condition thus determined, the feature game is run. As is understood from this, the random determination odds for determining the advantageous condition of the feature game are varied, based on a combination of the character setting selected by the player and the stage setting. This structure allows wider variation of the advantageous conditions to be determined, than a structure that determines the advantageous condition when the player selects the character setting. Thus, there is provided a slot machine 10 having an improved entertainment characteristic.

Further, the slot machine 10 of the present embodiment may further include a notification device (upper image display panel 131, lower image display panel 141, lamp 111, speaker 112, or the like) for notifying the player of the advantageous condition, wherein the game controller 100 notifies the player of the advantageous condition determined via the notification device.

With the structure, the advantageous condition determined is notified to the player via the notification device. This may enable the player to grasp the level of the advantageous condition by effects such as displaying an image of a character with a stronger item or outputting a larger sound for a better advantageous condition. Thus, there is provided a slot machine 10 having an improved entertainment characteristic.

Further, the slot machine 10 of the present embodiment may further include a display device (upper image display panel 131, lower image display panel 141, or the like) for displaying an image, wherein the game controller 100 may display on the display device the character according to the character setting determined, and the item of the character according to the advantageous condition.

With this, the display device displays the character according to the character setting determined. Further, an item of the character is displayed on the display device according to the advantageous condition determined. This may enable the player to visually grasp the level of the advantageous condition by effects such as displaying an image of a character with a stronger item for a better advantageous condition. Thus, there is provided a slot machine 10 having an improved entertainment characteristic.

The present embodiment deals with a case where the number of paylines L is 25; however, the number of paylines is not limited in the present invention. For example, the number of paylines may be 30.

The present embodiment deals with a case where the feature In occurs when three or more feature symbols 503b are rearranged. However, the feature In is not limited to this. For example, feature In may occur when a predetermined time has elapsed since the last feature game has ended.

Further, the present embodiment deals with a case of applying the present invention to a slot machine 10.

However, the present invention is applicable to other gaming machine such as so-called pachinko gaming machines.

Further, in the present embodiment, the feature game is a game in which displaying of symbols 501 on display blocks 28 are varied and stopped, and then an amount of payout is determined according to the symbols 501 having stopped or a combination of the stopped symbols 501 (i.e. a game normally run in a slot machine 10). However, the feature game of the present invention is not limited to this, and the feature game may be different from a game run in a slot machine 10. Examples of the feature game include: a card game such as poker, a shooting game, a fighting game, or the like. The feature game may be a game that awards a game medium or a game awarding no game medium.

The feature game in the present embodiment may be suitably designed, and is not particularly limited, as long as the feature game requires no bet of a game medium.

The above embodiments thus described solely serve as a specific example of the present invention, and the present invention is not limited to such an example. Specific structures and various means may be suitably designed or modified. Further, the effects of the present invention described in the above embodiment are not more than examples of most preferable effects achievable by the present invention. The effects of the present invention are not limited to those described in the embodiments described above.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined process function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### INDUSTRIAL APPLICABILITY

The present invention is applicable to gaming machines in general which run a bonus game.

What is claimed is:

1. A gaming machine, comprising:
an advantageous condition storage device for storing a plurality of advantageous conditions each related to an advantage level of a player in a game;
an effect setting storage device for storing a plurality of first settings and a plurality of second settings each related to an effect of the game;
a first setting selection button to be operated by the player for selecting one of the plurality of first settings stored in the effect setting storage device; and
a controller,
wherein the controller is programmed to perform the processes of:
(a1) running a base game configured to award a payout according to a predetermined combination;
(a2) when the predetermined condition is met in the base game, shifting a gaming mode to a special game which is more advantageous for the player than the base game;
(a3) receiving an operation of the first setting selection button by the player;
(a4) determining a first setting based on the operation by the player;
(a5) randomly determining a second setting out of the plurality of second settings stored in the effect setting storage device;
(a6) determining the random determination odds based on the combination of the first setting and the second setting;
(a7) based on the random determination odds, randomly determining an advantageous condition out of the plurality of advantageous conditions stored in the advantageous condition storage device; and
(a8) running the special game based on the advantageous condition determined.

2. The gaming machine according to claim 1, further comprising:
a notification device for notifying the player of the advantageous condition,
wherein the controller notifies the player of the advantageous condition determined via the notification device.

3. The gaming machine according to claim 1, further comprising:
a display device for displaying an image,
wherein the controller displays on the display device a character according to the first setting determined, and an item of the character according to the advantageous condition.

4. A gaming machine, comprising:
an advantageous condition storage device for storing a plurality of advantageous conditions each related to an advantage level of a player in a game;
an effect setting storage device for storing a plurality of first settings and a plurality of second settings each related to an effect of the game;
a first setting selection button to be operated by the player for selecting one of the plurality of first settings stored in the effect setting storage device;
a second setting selection button to be operated by the player for selecting one of the plurality of second settings stored in the effect setting storage device; and
a controller,
wherein the controller is programmed to perform the processes of:
(b1) running a base game configured to award a payout according to a predetermined combination;
(b2) when the predetermined condition is met in the base game, shifting a gaming mode to a special game which is more advantageous for the player than the base game;
(b3) receiving an operation of the first setting selection button and the second setting selection button by the player;
(b4) determining the first setting and the second setting based on the operation by the player;
(b5) determining the random determination odds based on the combination of the first setting and the second setting;
(b6) based on the random determination odds, randomly determining an advantageous condition out of the plurality of advantageous conditions stored in the advantageous condition storage device; and
(b7) running the special game based on the advantageous condition determined.

5. The gaming machine according to claim 4, further comprising:
further include a notification device for notifying the player of the advantageous condition,
wherein the controller notifies the player of the advantageous condition determined via the notification device.

6. The gaming machine according to claim 4, further comprising:
a display device for displaying an image,
wherein the controller displays on the display device a character according to the first setting determined, and an item of the character according to the advantageous condition.

7. A playing method of a gaming machine capable of running a base game configured to award a payout according to a predetermined combination, and running a special game which is more advantageous for the player than the base game,
the method comprising the steps of:
(c1) running the base game;
(c2) when the predetermined condition is met in the base game, shifting a gaming mode to a special game;
(c3) receiving an operation by the player;
(c4) based on the operation by the player, determining one of a plurality of first settings for effects of the game;
(c5) randomly determining one of a plurality of second settings for effects of the game;
(c6) determining random determination odds based on a combination of the first setting and the second setting thus determined;
(c7) based on the random determination odds, randomly determining one of a plurality of advantageous conditions in relation to an advantage level of the player in the special game; and
(c8) running the special game based on the advantageous condition determined.
